(19) United States
(12) Patent Application Publication
(10) Pub. No.: US 2026/0083536 A1
(43) Pub. Date: Mar. 26, 2026

(54) MODULAR INTRAORAL IMAGING DEVICE

(71) Applicant: Align Technology, Inc., San Jose, CA (US)

(72) Inventors: Edi Fridman, Rishon Le Zion (IL); Moshe Alboher, Tsoran (IL)

(21) Appl. No.: 19/326,566

(22) Filed: Sep. 11, 2025

Related U.S. Application Data
(60) Provisional application No. 63/697,445, filed on Sep. 20, 2024.

(51) Int. Cl. A61C 9/00

(52) U.S. Cl. CPC A61C 9/006; A61C 9/0093; A61C 2204/00

(57) ABSTRACT

An intraoral imaging device comprises a base and a removable probe coupled to the base. The base comprises a processing device configured to control operation of the intraoral imaging device and a first connector at a distal end of the base. The removable probe comprises one or more structured light projectors configured to project a light pattern, a plurality of cameras configured to image the projected light pattern to produce intraoral image data, and a second connector at a first end of the removable probe. The second connector mates with the first connector to provide a power connection between the removable probe and the base and a data connection between the removable probe and the base.

### RELATED APPLICATIONS

This patent application claims the benefit under 35 U.S.C. § 119(e) of U.S. Provisional Application No. 63/697,445, filed Sep. 20, 2024, which is incorporated by reference herein.

### TECHNICAL FIELD

Embodiments of the present disclosure relate to the field of dental imaging and, in particular, to a modular intraoral imaging device that uses swappable active probes.

### BACKGROUND

In prosthodontic procedures designed to implant a dental prosthesis in the oral cavity, the dental site at which the prosthesis is to be implanted in many cases should be measured accurately and studied carefully, so that a prosthesis such as a crown, denture or bridge, for example, can be properly designed and dimensioned to fit in place. A good fit enables mechanical stresses to be properly transmitted between the prosthesis and the jaw, and to prevent infection of the gums via the interface between the prosthesis and the dental site, for example.

Some procedures also call for prosthetics to be fabricated to replace one or more missing teeth, such as a partial or full denture, in which case the surface contours of the areas where the teeth are missing need to be reproduced accurately so that the resulting prosthetic fits over the edentulous region with even pressure on the soft tissues.

In some practices, the dental site is prepared by a dental practitioner, and a positive physical model of the dental site is constructed using known methods. Alternatively, the dental site may be scanned to provide 3D data of the dental site. In either case, the virtual or real model of the dental site is sent to the dental lab, which manufactures the prosthesis based on the model. However, if the model is deficient or undefined in certain areas, or if a preparation was not optimally configured for receiving the prosthesis or is inaccurate, the design of the prosthesis may be less than optimal.

In orthodontic procedures it can be important to provide a model of one or both jaws. Where such orthodontic procedures are designed virtually, a virtual model of the dental arches is also beneficial. Such a virtual model may be obtained by scanning the oral cavity directly, or by producing a physical model of the dentition, and then scanning the model with a suitable scanner.

Thus, in both prosthodontic and orthodontic procedures, obtaining a three-dimensional (3D) model of a dental arch in the oral cavity is an initial procedure that is performed. When the 3D model is a virtual model, the more complete and accurate the scans of the dental arch are, the higher the quality of the virtual model, and thus the greater the ability to design an optimal prosthesis or orthodontic treatment appliance(s).

Existing intraoral scanners have fixed, integrated probes with set arrangements of optics, cameras, light sources, and so on. Such intraoral scanners lack flexibility.

### SUMMARY

In a first aspect of the disclosure, an intraoral imaging device comprises: a base comprising: a processing device configured to control operation of the intraoral imaging device; a power supply configured to power the intraoral imaging device; a communications module configured to communicate with a computing device; and one or more first connectors at a distal end of the base, wherein the one or more first connectors comprise one or more first contacts and one or more second contacts; and a removable probe comprising: one or more structured light projectors configured to project a light pattern; a plurality of cameras configured to image the projected light pattern to produce intraoral image data; and one or more second connectors at a first end of the removable probe, wherein the one or more second connectors comprise one or more third contacts configured to mate with the one or more first contacts to provide a power connection between the removable probe and the base and comprise one or more fourth contacts configured to mate with the one or more second contacts to provide a data connection between the removable probe and the base, wherein the processing device is configured to receive the intraoral image data from the plurality of cameras via the data connection and to send the intraoral image data to the computing device via the communications module.

### BRIEF DESCRIPTION OF THE DRAWINGS

The present disclosure is illustrated by way of example, and not by way of limitation, in the figures of the accompanying drawings.

FIG. 1 illustrates one embodiment of a system for performing intraoral scanning and/or generating a virtual three-dimensional model of a dental site.

FIG. 2A is a schematic illustration of a modular intraoral imaging device comprising a removable probe connected to a base, in accordance with some applications of the present disclosure.

FIG. 2B is a schematic illustration of the modular intraoral imaging device of FIG. 2A with the removable probe disconnected from the base, in accordance with some applications of the present disclosure.

FIG. 3 is a schematic illustration of the modular intraoral imaging device of FIG. 2A with a different removable probe connected to the base, in accordance with some applications of the present disclosure.

FIG. 4 is a schematic illustration of a removable probe configured for attachment to the base of FIG. 2A, in accordance with some applications of the present disclosure.

FIG. 5 is a schematic illustration of an additional removable probe configured for attachment to the base of FIG. 2A, in accordance with some applications of the present disclosure.

FIG. 6A is a schematic illustration of a modular intraoral imaging device comprising a removable probe connected to a base via a disposable connector, in accordance with some applications of the present disclosure.

FIG. 6B is a schematic illustration of a modular intraoral imaging device with a protective sleeve, in accordance with some applications of the present disclosure.

FIGS. 7A-7B comprise schematic illustrations of positioning configurations for cameras and structured light projectors of an intraoral scanner, in accordance with some applications of the present disclosure.

FIG. 8 is a chart depicting a plurality of different configurations for the position of structured light projectors and cameras in a probe of an intraoral scanner, in accordance with some applications of the present disclosure.

FIG. 9 illustrates a block diagram of an example computing device, in accordance with embodiments of the present disclosure.

### DETAILED DESCRIPTION

Described herein is a modular intraoral imaging device that includes a base (also referred to as a wand or body) and a removable probe (also referred to as a tip) removably attached to the base. In some embodiments, the intraoral imaging device is an intraoral scanner. The removable probe may include active (e.g., powered) elements such as cameras and light sources (e.g., structured light projectors) in embodiments. The removable probe may be removed from the base, and other removable probes having different components, configurations, applications, uses, etc. may be attached to the base. For example, a first removable probe may be sized for intraoral scanning of adults, and a second removable probe may be sized for intraoral scanning of children.

In some particular applications of the present disclosure, an intraoral imaging device is an intraoral scanner. The functionality of the intraoral imaging device may depend at least in part on a type of removable probe attached to a base of the intraoral imaging device. If certain probes designed for intraoral scanning are attached to the intraoral imaging device, then the intraoral imaging device may function as an intraoral scanner. If other probes designed for other types of imaging applications (e.g., a probe for measuring pocket depths) are attached to the base, then the intraoral imaging device may not function as an intraoral scanner, and may instead operate as another type of intraoral imaging device.

In embodiments, the base and removable probes that attach to the base of a modular intraoral imaging device each include one or more connectors that can carry high-speed MIPI signals for multiple cameras, are of small size (small enough to fit into an end of a removable probe), and support a large number of mating cycles (e.g., at least 500 mating cycles in one embodiment). Use of such connectors enables the removable probes to have multiple active components (e.g., cameras) that are powered and controlled by components in the base. Users may swap out removable probes with different removable probes to modify a functionality of the intraoral imaging device, greatly expanding the use cases, flexibility, and usefulness of the intraoral imaging device.

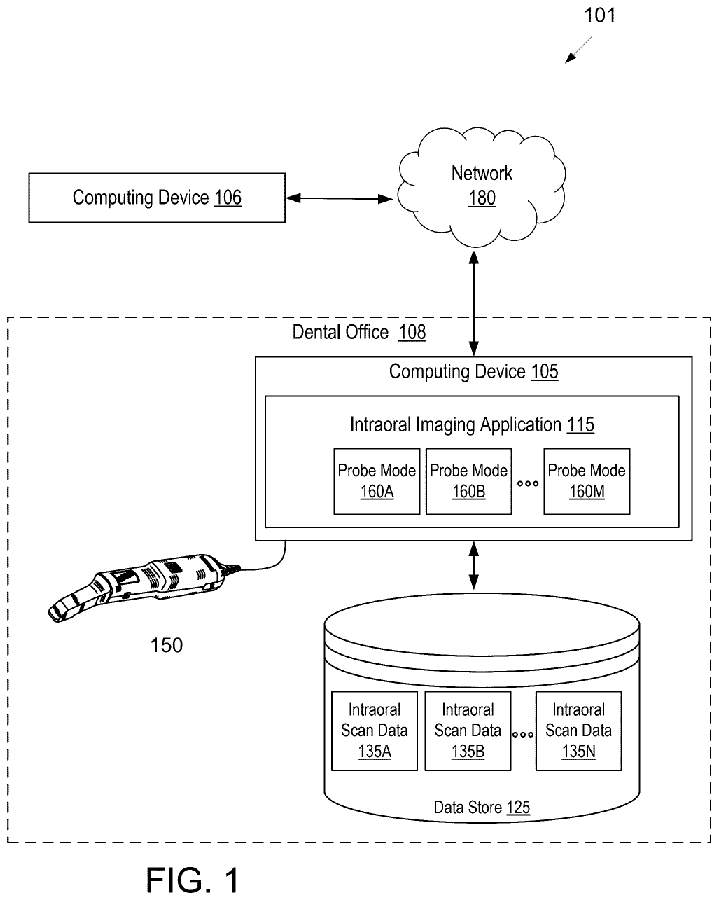

Turning now to the figures, FIG. 1 illustrates one embodiment of a system 101 for performing one or more types of intraoral imaging (e.g., intraoral scanning) and/or generating a three-dimensional (3D) surface and/or a virtual three-dimensional model of a dental site. System 101 includes a dental office 108 and optionally a remote computing device 106 (e.g., a server computing device). The dental office 108 includes a computing device 105 operatively connected to an intraoral imaging device 150 (e.g., such as an intraoral scanner). The computing devices 105, 106 may be connected to one another via a network 180 in embodiments. The network 180 may be a local area network (LAN), a public wide area network (WAN) (e.g., the Internet), a private WAN (e.g., an intranet), or a combination thereof.

Computing device 105 may be coupled to intraoral imaging device 150 (also referred to as a scanner) and/or a data store 125 via a wired or wireless connection. In one embodiment, intraoral imaging device 150 is wirelessly connected to computing device 105 via a direct wireless connection. In one embodiment, intraoral imaging device 150 is wirelessly connected to computing device 105 via a wireless network. In one embodiment, the wireless network is a Wi-Fi network. In one embodiment, the wireless network is a Bluetooth network, a Zigbee network, or some other wireless network. In one embodiment, the wireless network is a wireless mesh network, examples of which include a Wi-Fi mesh network, a Zigbee mesh network, and so on. In an example, computing device 105 may be physically connected to one or more wireless access points and/or wireless routers (e.g., Wi-Fi access points/routers). Intraoral imaging device 150 may include a wireless module such as a Wi-Fi module, and via the wireless module may join the wireless network via the wireless access point/router.

Computing device 106 may also be connected to a data store (not shown). The data stores may include local data stores and/or remote data stores. Computing device 105 and computing device 106 may each include one or more processing devices, memory, secondary storage, one or more input devices (e.g., such as a keyboard, mouse, tablet, touchscreen, microphone, camera, and so on), one or more output devices (e.g., a display, printer, touchscreen, speakers, etc.), and/or other hardware components.

Computing device 105 and/or data store 125 may be located at dental office 108 (as shown). In one embodiment, computing device 106 is located at a server farm that provides a cloud computing service. In an example, computing device 106 may include a remote server, and some operations of intraoral imaging application 115 may be performed on computing device 105 and some operations of intraoral imaging application 115 may be performed on the remote server of computing device 106.

Intraoral imaging device 150 may include a body or base and a removable probe attached to the base. The removable probe may be configured for optically capturing three-dimensional oral structures in embodiments. The intraoral imaging device 150 may be configured such that the base can accept multiple different types of removable probes. Each of the different types of removable probes may be designed for a different application or purpose. Some of the removable probes may be designed for intraoral scanning (e.g., may comprise intraoral scanner capabilities). Other removable probes may be designed for different types of intraoral imaging and/or measuring applications (e.g., may comprise non-intraoral scanner capabilities such as performing pocket depth measurements).

The intraoral imaging device 150 may be used to perform intraoral imaging (e.g., intraoral scanning) of a patient's oral cavity. An intraoral imaging application 115 running on computing device 105 may communicate with the intraoral imaging device 150 to effectuate an intraoral scan and/or other intraoral imaging operation. A result of the intraoral scan may be intraoral image data 135A, 135B through 135N that may include one or more sets of intraoral scans and/or sets of intraoral 2D images and/or other intraoral image data. Each intraoral scan may include a 3D image or point cloud that may include depth information of a portion of a dental site. In embodiments, intraoral scans include x, y and z information.

A captured 3D image or point cloud may be generated based on multiple 2D images captured in parallel (e.g., at the same time) by different cameras. Intraoral imaging device 150 may include one or more structured light projectors that output structured light (e.g., one or more light patterns comprising projected pattern features) at one or a few wavelengths, which may illuminate a dental site with the structured light. Multiple cameras of the intraoral imaging device 150 may capture images of the dental site illuminated by the structured light from different angles. The arrangement of cameras and structured light projectors may be different for different removable probes that are usable with the base of the intraoral imaging device 150. Captured images may be 2D images of the dental site illuminated by the structured light (e.g., that include captured pattern features of the structured light).

In some embodiments (e.g., with some removable probes), triangulation may be performed to determine the depth information about the 2D images. For example, each point or captured pattern feature of the structured light captured in one or more 2D images may have known 2D coordinates, but may initially lack depth information. The depth information may be determined using triangulation based on known information about a location of an origin of a projector ray of a structured light projector that caused a point or projected pattern feature to appear on the dental site and a location of a camera sensor that captured the point. Additionally, for points (e.g., captured pattern features) captured in multiple images (e.g., each image captured by a different camera), known locations of camera sensors of the multiple cameras in the removable probe (which may be dependent on the design of the removable probe in use) may additionally or alternatively be used to perform triangulation and determine the depth of the point/captured pattern feature. However, it can be difficult to determine which projector rays/projected pattern features correspond to which points/captured pattern features (e.g., which spots or other structured light features) in the captured 2D images. Accordingly, in embodiments intraoral imaging application 115 and/or other logic processes captured images to determine which points/captured pattern features in captured images correspond to which projector rays/projected pattern features of the structured light projector(s). Details for solving such a correspondence problem are set forth in U.S. Pat. No. 11,563,929, issued Jan. 24, 2023, and U.S. Pat. No. 11,896,461, issued Feb. 13, 2024, both of which are incorporated by reference herein in their entirety.

Intraoral image data 135A-N may also include color 2D images and/or images of particular wavelengths (e.g., near-infrared (NIRI) images, infrared images, ultraviolet images, etc.) of a dental site, depending on the removable probe in use in embodiments. In embodiments, intraoral imaging device 150 alternates between generation of 3D intraoral scans (e.g., in which structured light is projected and 2D images of a dental site illuminated by the structured light are captured and processed to determine 3D point clouds) and one or more types of 2D intraoral images (e.g., color images, NIRI images, etc.) during scanning. For example, one or more 2D color images may be generated between generation of a fourth and fifth intraoral scan by outputting white light and capturing reflections of the white light using multiple cameras. In some embodiments, a removable probe is used that uses patterned non-coherent (e.g., white) light, and that projects a light pattern from such light onto a surface being scanned. The pattern may be, for example, a checkerboard pattern. In instances where the light is white light, captured images of the light pattern on the intraoral surface may provide both color information and depth information.

Depending on the removable probe in use, intraoral imaging device 150 may include multiple different cameras (e.g., each of which may include one or more image sensors) that generate additional 2D images (e.g., 2D color images) of different regions of a patient's dental arch concurrently. Intraoral 2D images may include 2D color images, 2D infrared or near-infrared (NIRI) images, and/or 2D images generated under other specific lighting conditions (e.g., 2D ultraviolet images). The 2D images may be used by a user of the intraoral scanner to determine where the scanning face of the intraoral scanner is directed and/or to determine other information about a dental site being scanned. The 2D images may also be used to apply a texture mapping to a 3D surface and/or 3D model of the dental site generated from the intraoral scans.

The intraoral imaging device 150 may transmit the intraoral image data 135A, 135B through 135N to the computing device 105. Computing device 105 may store some or all of the intraoral image data 135A-135N in data store 125. In some embodiments, intraoral imaging application 115 processes the intraoral image data 135A-N to determine which points in captured 2D images correspond to which projector rays of structured light projectors (e.g., which captured pattern features correspond to which projected pattern features of the structured light pattern), and to ultimately generate a 3D point cloud based on the points/corresponding pattern features in the 2D images.

According to an example, a user (e.g., a practitioner) may subject a patient to intraoral scanning. In doing so, the user may apply intraoral imaging device 150 having an intraoral scanning probe to one or more patient intraoral locations. The scanning may be divided into one or more segments (also referred to as roles). As an example, the segments may include a lower dental arch of the patient, an upper dental arch of the patient, one or more preparation teeth of the patient (e.g., teeth of the patient to which a dental device such as a crown or other dental prosthetic will be applied), one or more teeth which are contacts of preparation teeth (e.g., teeth not themselves subject to a dental device but which are located next to one or more such teeth or which interface with one or more such teeth upon mouth closure), and/or patient bite (e.g., scanning performed with closure of the patient's mouth with the scan being directed towards an interface area of the patient's upper and lower teeth). Via such scanner application, the intraoral imaging device 150 may provide intraoral image data 135A-N to computing device 105. The intraoral image data 135A-N may be provided in the form of intraoral image data sets, each of which may include 2D intraoral images (e.g., color 2D images) and/or 3D intraoral scans (e.g., based on 2D images of a dental site illuminated by structured light) of particular teeth and/or regions of an dental site. In one embodiment, separate intraoral image data sets are created for the maxillary arch, for the mandibular arch, for a patient bite, and/or for each preparation tooth. Alternatively, a single large intraoral image data set is generated (e.g., for a mandibular and/or maxillary arch).

Intraoral scans may be provided from the intraoral imaging device 150 to the computing device 105 in the form of one or more points (e.g., one or more pixels and/or groups of pixels). For instance, the scanner 150 may provide an intraoral scan as one or more point clouds. The intraoral scans may each comprise height information (e.g., a height map that indicates a depth for each pixel). In some embodiments, the intraoral scans include multiple 2D images of a dental site illuminated by one or more structured light projectors, which are then processed to generate a 3D point cloud. The processing of the 2D images may be performed on the intraoral imaging device 150 before transmission to the computing device 105 or may be performed on the computing device 105 after receipt of the 2D images from intraoral imaging device 150.

The manner in which the oral cavity of a patient is to be scanned may depend on the procedure to be applied thereto and/or on the type of removable probe that is in use. For example, if an upper or lower denture is to be created, then a full scan of the mandibular or maxillary edentulous arches may be performed. In contrast, if a bridge is to be created, then just a portion of a total arch may be scanned which includes an edentulous region, the neighboring preparation teeth (e.g., abutment teeth) and the opposing arch and dentition. Alternatively, full scans of upper and/or lower dental arches may be performed if a bridge is to be created.

By way of non-limiting example, dental procedures may be broadly divided into prosthodontic (restorative) and orthodontic procedures, and then further subdivided into specific forms of these procedures. Additionally, dental procedures may include identification and treatment of gum disease, sleep apnea, and intraoral conditions. The term prosthodontic procedure refers, inter alia, to any procedure involving the oral cavity and directed to the design, manufacture or installation of a dental prosthesis at a dental site within the oral cavity (dental site), or a real or virtual model thereof, or directed to the design and preparation of the dental site to receive such a prosthesis. A prosthesis may include any restoration such as crowns, veneers, inlays, onlays, implants and bridges, for example, and any other artificial partial or complete denture. The term orthodontic procedure refers, inter alia, to any procedure involving the oral cavity and directed to the design, manufacture or installation of orthodontic elements at a dental site within the oral cavity, or a real or virtual model thereof, or directed to the design and preparation of the dental site to receive such orthodontic elements. These elements may be appliances including but not limited to brackets and wires, retainers, clear aligners, or functional appliances.

In embodiments, intraoral imaging may be performed on a patient's oral cavity during a visitation of dental office 108. The intraoral imaging may be performed, for example, as part of a semi-annual or annual dental health checkup. The intraoral imaging may also be performed before, during and/or after one or more dental treatments, such as orthodontic treatment and/or prosthodontic treatment. The intraoral imaging may be or include a full or partial scan of the upper and/or lower dental arches, and may be performed in order to gather information for performing dental diagnostics, to generate a treatment plan, to determine progress of a treatment plan, and/or for other purposes. The dental information (intraoral image data 135A-N) generated from the intraoral imaging may include 3D scan data, 2D color images, NIRI and/or infrared images, and/or ultraviolet images, of all or a portion of the upper jaw and/or lower jaw. In some embodiments, the removable probe in use is capable of performing fluorescent imaging. The intraoral image data 135A-N may further include one or more intraoral scans showing a relationship of the upper dental arch to the lower dental arch. These intraoral scans may be usable to determine a patient bite and/or to determine occlusal contact information for the patient. The patient bite may include determined relationships between teeth in the upper dental arch and teeth in the lower dental arch.

Intraoral scanning may work by moving the intraoral imaging device 150 inside a patient's mouth to capture all viewpoints of one or more tooth. During scanning, the intraoral imaging device 150 is calculating distances to solid surfaces in some embodiments. These distances may be recorded as 3D point clouds in some embodiments. Each scan (e.g., point cloud) is overlapped algorithmically, or ‘stitched’, with the previous set of scans to generate a growing 3D surface. As such, each scan is associated with a rotation in space, or a projection, to how it fits into the 3D surface.

During intraoral scanning, intraoral imaging device 150 may generate multiple images, each containing captured structured light features (also referred to as captured pattern features) that correspond to projected structured light features projected by structured light projectors of the intraoral imaging device 150. The intraoral imaging device 150 may include an onboard processing device that processes these images to find correspondence between projected pattern features and captured pattern features to determine depth information of captured pattern features. A point cloud may be generated, which may be transmitted to the computing device 105. Alternatively, the images may be transmitted to the computing device 105, and the intraoral imaging application 115 may determine the correspondence between the projected pattern features and the captured pattern features.

In an example, a processing device of intraoral imaging device and/or the intraoral imaging application 115 may run a surface reconstruction algorithm that may use detected patterns (e.g., dot patterns, pattern features of a checkerboard pattern, etc.) projected onto an intraoral object to generate a 3D surface of the object. The surface reconstruction algorithm may solve a correspondence problem between projected pattern features and captured patterned features to determine depth information of each of the captured pattern features in embodiments. In some embodiments, the processing device and/or intraoral scan application may combine at least one 3D scan captured using illumination from structured light projectors with a plurality of intraoral 2D images captured using illumination from a uniform (e.g., white) light projector in order to generate a digital three-dimensional image of the intraoral three-dimensional surface. Using a combination of structured light and uniform illumination enhances the overall capture of the intraoral scanner and may help reduce the number of options that processor needs to consider when running a correspondence algorithm used to detect depth values for object in some embodiments.

During intraoral scanning, intraoral imaging application 115 may register and stitch together two or more intraoral scans generated thus far from the intraoral scan session to generate a growing 3D surface. In one embodiment, performing registration includes capturing 3D data of various points of a surface in multiple scans, and registering the scans by computing transformations between the scans. One or more 3D surfaces may be generated based on the registered and stitched together intraoral scans during the intraoral scanning. The one or more 3D surfaces may be output to a display so that a doctor or technician can view their scan progress thus far. As each new intraoral scan is captured and registered to previous intraoral scans and/or a 3D surface, the one or more 3D surfaces may be updated, and the updated 3D surface(s) may be output to the display. A view of the 3D surface(s) may be periodically or continuously updated according to one or more viewing modes of the intraoral scan application. In one viewing mode, the 3D surface may be continuously updated such that an orientation of the 3D surface that is displayed aligns with a field of view of the intraoral scanner (e.g., so that a portion of the 3D surface that is based on a most recently generated intraoral scan is approximately centered on the display or on a window of the display) and a user sees what the intraoral scanner sees. In one viewing mode, a position and orientation of the 3D surface is static, and an image of the intraoral scanner is optionally shown to move relative to the stationary 3D surface.

Intraoral imaging application 115 may generate one or more 3D surfaces from intraoral scans, and may display the 3D surfaces to a user (e.g., a doctor) via a graphical user interface (GUI) during intraoral scanning. In embodiments, separate 3D surfaces are generated for the upper jaw and the lower jaw. This process may be performed in real time or near-real time to provide an updated view of the captured 3D surfaces during the intraoral scanning process. As scans are received, these scans may be registered and stitched to a 3D surface.

When a scan session or a portion of a scan session associated with a particular scanning role (e.g., upper jaw role, lower jaw role, bite role, etc.) is complete (e.g., all scans for an dental site or dental site have been captured), intraoral imaging application 115 may generate a virtual 3D model of one or more scanned dental sites (e.g., of an upper jaw and a lower jaw). The final 3D model may be a set of 3D points and their connections with each other (i.e. a mesh). To generate the virtual 3D model, intraoral imaging application 115 may register and stitch together the intraoral scans generated from the intraoral scan session that are associated with a particular scanning role. The registration performed at this stage may be more accurate than the registration performed during the capturing of the intraoral scans, and may take more time to complete than the registration performed during the capturing of the intraoral scans. In one embodiment, performing scan registration includes capturing 3D data of various points of a surface in multiple scans, and registering the scans by computing transformations between the scans. The 3D data may be projected into a 3D space of a 3D model to form a portion of the 3D model. The intraoral scans may be integrated into a common reference frame by applying appropriate transformations to points of each registered scan and projecting each scan into the 3D space.

In one embodiment, registration is performed for adjacent or overlapping intraoral scans (e.g., each successive frame of an intraoral video). Registration algorithms are carried out to register two adjacent or overlapping intraoral scans and/or to register an intraoral scan with a 3D model, which essentially involves determination of the transformations which align one scan with the other scan and/or with the 3D model. Registration may involve identifying multiple points in each scan (e.g., point clouds) of a scan pair (or of a scan and the 3D model), surface fitting to the points, and using local searches around points to match points of the two scans (or of the scan and the 3D model). For example, intraoral imaging application 115 may match points of one scan with the closest points interpolated on the surface of another scan, and iteratively minimize the distance between matched points. Other registration techniques may also be used.

Intraoral imaging application 115 may repeat registration for all intraoral scans of a sequence of intraoral scans to obtain transformations for each intraoral scan, to register each intraoral scan with previous intraoral scan(s) and/or with a common reference frame (e.g., with the 3D model). Intraoral imaging application 115 may integrate intraoral scans into a single virtual 3D model by applying the appropriate determined transformations to each of the intraoral scans. Each transformation may include rotations about one to three axes and translations within one to three planes.

Intraoral imaging application 115 may generate one or more 3D models from intraoral scans, and may display the 3D models to a user (e.g., a doctor) via a graphical user interface (GUI). The 3D models can then be checked visually by the doctor. The doctor can virtually manipulate the 3D models via the user interface with respect to up to six degrees of freedom (i.e., translated and/or rotated with respect to one or more of three mutually orthogonal axes) using suitable user controls (hardware and/or virtual) to enable viewing of the 3D model from any desired direction. If scaling of image on screen is also considered, than the doctor can virtually manipulate the 3D models with respect to up to seven degrees of freedom (the previously described six degrees of freedom in addition to zoom or scale).

After completion of the 3D surface(s) and/or 3D model(s) and/or during generation of the 3D surface(s) and/or 3D model(s) intraoral imaging application 115 may perform texture mapping to map color information to the 3D surface(s) and/or 3D model(s). Color images (e.g., images generated under white light conditions) may be processed, and color information from these color images may be added to the 3D surface(s) and/or 3D model(s). In some embodiments, the color information is used to improve an accuracy of solving the correspondence problem for at least some points in captured 2D images of intraoral scans.

Multiple different types of removable probes may be used for intraoral imaging device 150. In order for a removable probe to function properly, the intraoral imaging device 150 should be configured and calibrated for operation with the specific removable probe attached to the base of the intraoral imaging device 150 at a given time. Different types of removable probes may have different numbers, types and/or arrangements of cameras, structured light projectors, non-structured light projectors, other measurement devices (e.g., pocket depth probes), and so on. In order for the intraoral imaging device 150 to properly process data generated by the removable probe, the type of removable probe that is attached to the base should be determined. In some embodiments, the removable probe includes a memory (e.g., non-volatile or read only memory) that stores thereon a unique identifier (ID) of the removable probe. When the removable probe is attached to the base, a processing device of the base may perform a read operation on the memory to determine the unique ID of the removable probe. The unique ID may indicate a probe type of the removable probe. Based on the probe type, the processing device may update a configuration of the intraoral imaging device 150 (e.g., may configure one or more parameters of the intraoral imaging device based at least in part on the determined probe type). The intraoral imaging device 150 may additionally or alternatively report the probe type to computing device 105 (e.g., by sending the unique ID to the computing device 105). The computing device 105 may configure one or more settings of intraoral scan application 115 based at least in part on the probe type, which computing device 105 may determine based on the unique ID in embodiments.

In some embodiments, intraoral imaging application 115 may include multiple different modes of operation, where the different modes of operation may be associated with different probe types. For example, intraoral imaging application may include probe mode 160A, probe mode 160B through probe mode 160M, each of which may be associated with a different type of probe. In some embodiments, updating the configuration of the processing device may include updating a firmware of the processing device and/or a software running on the processing device. In some embodiments, intraoral imaging application 115 and/or the processing device of intraoral imaging device 150 may not initially support a new probe type, and computing device 105 may download a software update, firmware update and/or patch from computing device 106 which may then be run to enable intraoral scan application 115 to support the new probe type. In some embodiments, computing device 105 may send a firmware and/or software update to intraoral imaging device 150 to enable intraoral imaging device 150 to support a new probe type.

Each of the probe modes 160A-M may be associated with different software parameters. Different probe modes 160A-M may include different graphical user interface (GUI) features associated with different functionalities of the different probe types. Additionally, graphics of the GUI may change based on the different probe types (e.g., to properly reflect the arrangement of cameras and light projectors of a particular probe type in use). For example, when a larger removable probe (e.g., larger tip) is used, a visualization of the intraoral imaging device and/or of a FOV of the intraoral imaging device on the GUI will accordingly reflect the correct size associated with the current removable probe. When a removable probe provides additional or different functionality than other removable probes (e.g., one removable probe is for intraoral scanning and one is for pocket depth measurement), appropriate usage controls and/or gathered information may be presented in accordance with the currently used removable probe.

In embodiments, the removable probe may be removed from the base of the intraoral imaging device and be replaced with another removable probe while the intraoral imaging device is powered on and in use. For example, a 3D surface showing part of a dental arch may have been generated during scanning of the dental arch using a first removable probe. However, a back molar may be difficult to scan with the current removable probe. The removable probe may be swapped out with a different removable probe configured specifically for scanning in hard to reach locations such as for scanning of the back molars. Scanning may then commence using the new removable probe to capture further intraoral scan data, which may be registered to the 3D surface that was already generated using the intraoral scan data captured using the first removable probe.

In some instances, the intraoral scan application may detect that a user is having trouble scanning a particular region of a patient's dentition, and may recommend swapping the currently used removable probe with an alternate removable probe that may be better able to capture the regions for which the user is having difficulty. In another example, intraoral imaging application may determine a size of a patient's oral cavity and recommend a particular removable probe to be used based on the detected size. Alternatively, or additionally, intraoral imaging application may recommend a particular removable probe based on an age of a patient. For example, a first removable probe may be smaller than a second removable probe, and may be recommended for patient's with small oral cavities and/or for use with children.

In one embodiment, the intraoral imaging device 150 may include a first type of removable probe, and may generate intraoral scan data using the first type of removable probe. The computing device 105 may determine, based at least in part on received intraoral scan data or a 3D model or 3D surface generated from the intraoral scan data, that a second type of removable probe is recommended. For example, if the 3D surface is missing data for one or more hard to reach regions of the patient's dentition (e.g., there are voids in the 3D model at the rear molars) after the user has attempted to scan the hard to reach regions for a threshold amount of time, the intraoral scan application 115 may determine that a user is having difficulty scanning the hard to reach region and may determine that a second probe type would have a higher chance of obtaining scan data for the hard to reach regions than the first probe type currently in use. The intraoral scan application 115 running on the computing device may then output a recommendation for the user to use the second probe type for scanning of the hard to reach regions. This may prompt a user to replace the current removable probe having the first probe type with the recommended second removable probe having the second probe type. The first probe type may have, for example, a first number of structured light projectors, a first number of cameras, first dimensions, a first arrangement of structured light projectors and/or cameras, first types of structured light projectors and/or cameras, and so on. In some embodiments, the first probe type may be sized for adult patients. The second probe type may have, for example, a second number of structured light projectors, a second number of cameras, second dimensions, a second arrangement of structured light projectors and/or cameras, second types of structured light projectors and/or cameras, and so on. In some embodiments, the second probe type may be sized for child patients.

Each individual probe may have been calibrated, and may include its own calibration values. Accordingly, two probes of the same type may have different calibration values. Calibration may have already been performed for a removable probe, and calibration values may be stored by the removable probe, by intraoral scan application 115 and/or by computing device 106 in embodiments. Calibration values for a removable probe may be determined using one or more techniques as set forth below, and a calibration of the intraoral imaging device 150 may be updated based on the one or more calibration values in embodiments. Calibration values may include, for example, relative positions and/or orientations of structured light projectors and/or cameras of the removable probe, optical aberrations of the removable probe, magnification values of the cameras for the removable probe, and so on.

In some embodiments, calibration values for a probe are stored in a memory of the probe and can be read by the processing device in the base of the intraoral imaging device 150.

In some embodiments, computing device 106 includes a data store that stores calibration values for each probe that has been manufactured. Each of the calibration values may be associated with a particular probe ID, and may be associated with a particular removable probe. Computing device 105 may receive a notice from intraoral imaging device 150 of a unique ID of the removable probe, and if the computing device 105 does not already include the calibration values for the removable probe having that unique ID, may send the unique ID to computing device 106. Computing device 106 may retrieve the calibration values associated with the removable probe and provide them to computing device 105. Computing device 105 may forward the calibration values to the intraoral imaging device 150, which may update one or more calibration settings of the intraoral imaging device 150 based on the calibration values. If the computing device 105 already includes the calibration values for the removable probe, then computing device 105 may send the calibration values to the intraoral imaging device 150 without first querying the remote computing device 106.

In some embodiments, once a particular probe has been used with a base of the intraoral imaging device 150, the base stores the calibration values for that probe in an onboard memory of the base, and subsequent times that the probe is connected to the base the processing device does not need to initiate any requests to obtain the calibration values (e.g., by reading a memory of the probe or by issuing a request to the intraoral imaging application 115). Instead, the processing device may retrieve the calibration values from memory based on the unique ID of the probe, which the processing device may read from the memory of the probe.

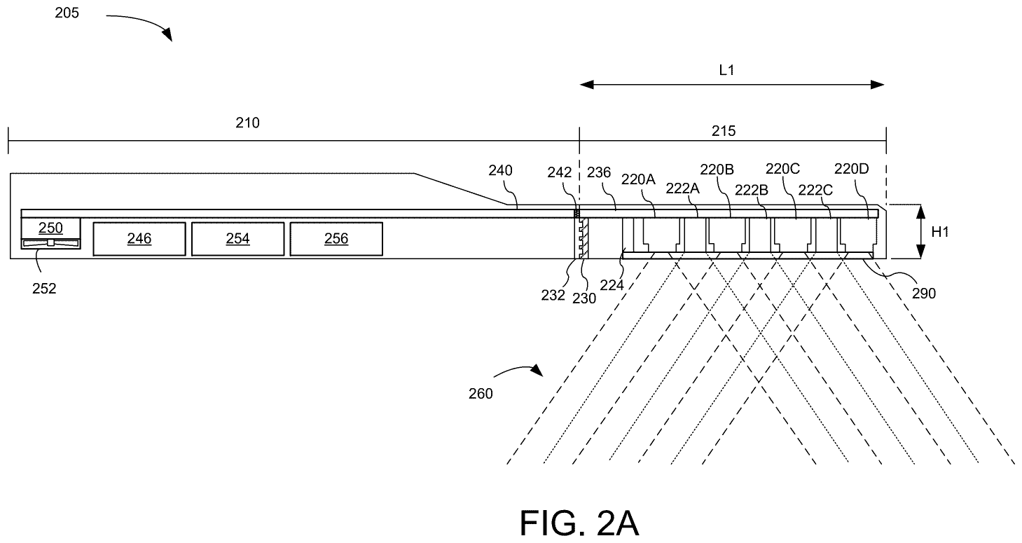

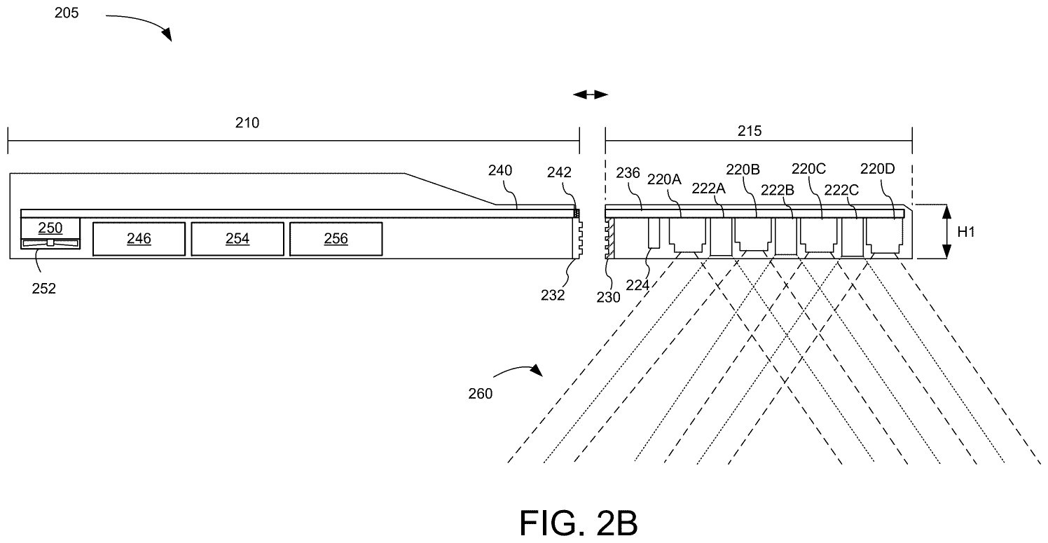

Reference is now made to FIG. 2A, which is a schematic illustration of an intraoral imaging device 205 comprising a base 210 (e.g., which may be an elongate handheld wand) and a removable probe 215 attached to the base 210, in accordance with some applications of the present disclosure. The intraoral imaging device 205 may correspond to intraoral imaging device 150 of FIG. 1 in embodiments. Intraoral imaging device 205 includes a plurality of structured light projectors 222A-C and a plurality of cameras 220A-D that are coupled to a rigid structure disposed within removable probe 215 at a distal end of the intraoral imaging device 205. In some applications, during an intraoral scanning or imaging procedure, removable probe 215 is inserted into the oral cavity of a subject or patient.

In embodiments, for at least one removable probe 215, the removable probe includes one or more structured light projectors 222A-C that are each configured to project a light pattern onto a dental site (e.g., an oral structure such as a tooth, gingiva, dental arch, or portion thereof). The removable probe 215 also includes multiple cameras 220A-D that are each configured to image the dental site illuminated by the structured light patterns projected by the structured light projectors. The multiple projectors and multiple cameras of the removable probe 215 may enable the removable probe 215 to have an enlarged field of view (e.g., as compared to an intraoral scanner having a single light projector and/or a single camera). The enlarged field of view enables the intraoral imaging device 205 to achieve higher accuracy and faster intraoral scanning as compared to an intraoral scanner that lacks multiple light projectors and/or that lacks multiple cameras.

In some embodiments, different removable probes may have different numbers and/or arrangements of structured light projectors and/or cameras, and as a result may have differently sized fields of view and/or different shaped fields of view. Additionally, different removable probes may have different imaging capabilities. For example, one or more removable probes may include white light projectors (e.g., that may or may not output light patterns) and cameras that capture color images, infrared or near infrared light projectors and cameras that capture infrared or near infrared images, light projectors and/or cameras that provide fluorescent imaging capabilities, light projectors of various coherent wavelengths (e.g., different lasers tuned to different wavelengths, etc.), and so on.

In some embodiments, different removable probes include structured light projectors that generate different light patterns (e.g., different density of light patterns). For example, one removable probe may include structured light projectors that project a sparse light pattern, while another removable probe may include structured light projectors that project a dense light pattern. Generally speaking, a denser structured light pattern may provide more sampling of an imaged surface, higher resolution, and enable better stitching of the respective surfaces obtained from multiple scan frames. However, too dense a structured light pattern may lead to a more complex correspondence problem between projected features (in projected light pattern) and captured features (in images) due to there being a larger number of light features for which to solve the correspondence problem. Additionally, a denser structured light pattern may have lower pattern contrast resulting from more light in the system, which may be caused by a combination of (a) stray light that reflects off the somewhat glossy surface of the teeth and may be picked up by the cameras, and (b) percolation, i.e., some of the light entering the teeth, reflecting along multiple paths within the teeth, and then leaving the teeth in many different directions. Accordingly, different densities of light patterns may be optimal for different use cases. A dense light pattern may be a light pattern in which greater than 20% of an area of projection includes projected light (e.g., less than 80% lacks features of the light pattern). A sparse light pattern may be a light pattern in which less than 20% of an area of projection includes projected light (e.g., greater than 80% lacks features of the light pattern).

In embodiments, the light projectors 222A-C and cameras 220A-D disposed in some removable probes may be non-telecentric, while the light projectors and/or cameras disposed in other removable probes may be telecentric. Cameras of different removable probes may have different predefined fields of view (FOV) and/or different predefined angular fields of view (AFOV). Similarly, light projectors of different removable probes may have different predefined fields of illumination (FOI) and/or different predefined angular fields of illumination (AFOI). The field of view (FOV) of a camera may be understood as the extent of the observable world that is seen at any given moment by the camera. The FOV may be reported as an area measure, e.g. an area at a given distance from the camera or at a given distance below the probe of the intraoral scanner. The angular field of view (AFOV) is correlated to the FOV, and the AFOI is correlated to the FOI. However, herein the AFOV and AFOI are expressed as angles and the FOV and FOI are expressed as an area. In embodiments, the light projectors of some removable probes have an AFOI that cause the FOI of the light projectors to become larger with increased distance from the intraoral scanner. Additionally or alternatively, the cameras of some removable probes have an AFOV that cause the FOV of the cameras to become larger with increased distance/depth from the intraoral scanner. The AFOI of the light projectors may cause light patterns projected by the respective light projectors to have different amounts of interference and/or overlap at different depths. The relationship between depth and amount of interference and/or overlap may very from removable probe to removable probe. Depth as used herein may refer to a distance between intraoral imaging device (e.g., the light projector and/or camera of the intraoral imaging device) and an imaged surface along an imaging axis that is orthogonal to a longitudinal axis of the intraoral imaging device (e.g., to a longitudinal axis of a removable probe of the intraoral imaging device that contains the cameras and light projectors).

A removable probe configured for intraoral scanning and/or other intraoral imaging functions may be configured to enter the intraoral cavity of a subject. Multiple light projectors (e.g., miniature structured light projectors) as well multiple cameras (e.g., miniature cameras) may be coupled to a rigid structure disposed within the probe. Each of the light projectors transmits light using a light source, such as a laser diode, light emitting diode (LED), etc. Each of the structured light projectors may be configured to project a pattern of light defined by a plurality of projector rays when the light source is activated. Each camera may be configured to capture a plurality of images that depict at least a portion of the projected pattern of light as projected by the multiple light projectors on an intraoral surface. In some applications, the light projectors may have an AFOI of at least 45 degrees. Optionally, the AFOI may be less than 120 degrees. For structured light projectors, each of the structured light projectors may further include a pattern generating optical element. In some embodiments, the pattern generating optical element may utilize diffraction and/or refraction to generate a light pattern in some embodiments. In some applications, the light pattern may be a distribution of discrete unconnected spots of light. In some applications, the light pattern may be a checkerboard pattern. Other light patterns such as grids, lines, regular distributions of polygons, etc. may additionally or alternatively be used. Optionally, the light pattern maintains the distribution of discrete unconnected spots or other pattern features at all planes located up to a threshold distance (e.g., 30 mm, 40 mm, 60 mm, etc.) from the pattern generating optical element, when the light source (e.g., laser diode) is activated to transmit light through the pattern generating optical element. Each of the cameras includes a camera sensor and objective optics including one or more lenses.

The structured light projectors 222A-C of some removable probes may project a light pattern that is non-coded. The structured light projectors 222A-C from other removable probes may project a light pattern that is coded.

The cameras of different removable probes may have different AFOVs. For example, the AFOV of each of the cameras of one or more removable probes may be at least 45 degrees, e.g., at least 80 degrees, e.g., 85 degrees. Optionally, the AFOV of each of the cameras of one or more removable probes may be less than 120 degrees, e.g., less than 90 degrees. The fields of view of the various cameras may together form a field of view of the intraoral imaging device. In any case, the fields of view and/or angular fields of view of the various cameras may be identical or non-identical, which may vary from probe to probe. Similarly, the focal length of the various cameras may be identical or non-identical, which may vary from probe to probe. Further, each camera may be configured to focus at an object focal plane that is located up to a threshold distance from the respective camera sensor (e.g., up to a distance of 10 mm, 20 mm, 30 mm, 40 mm, 50 mm, 60 mm, 70 mm, 80 mm, etc. from the respective camera sensor), which may vary from probe to probe. As distances increase, the accuracy of the position of the detected surfaces decreases. Different removable probes may have different accuracies at one or more depths. In some applications, the AFOI of each of the light projectors (e.g., structured light projectors and/or non-structured light projectors) may be at least 45 degrees and optionally less than 120 degrees, which may vary from probe to probe. A large field of view (FOV) of the removable probe achieved by combining the respective fields of view of all the cameras may improve accuracy (as compared to traditional scanners that typically have a FOV of 10-20 mm in the x-axis and y-axis and a depth of capture of about 0-15 or 025 mm) due to reduced amount of image stitching errors.

In edentulous regions, where the gum surface is smooth and there may be fewer clear high resolution 3-D features, a large FOV is particularly advantageous. Accordingly, a removable probe designed specifically for scanning of edentulous regions may have a greater number of cameras and/or structured light projectors, which may have a larger combined FOV than other removable probes. Since patients with edentulous dental arches generally have more space in the oral cavity than patients with teeth, a removable probe designed for use in edentulous oral cavities may be larger than other removable probes, which enables such a removable probe to contain a greater number of cameras and/or structured light projectors. Having a larger FOV for the intraoral scanner enables large smooth features, such as the overall curve of the tooth, to appear in each image frame, which improves the accuracy of stitching respective surfaces obtained from multiple such image frames.

In some applications, for at least one removable probe 215 the total combined FOV of the various cameras is between about 20 mm and about 50 mm along the longitudinal axis of the elongate wand, and about 20-60 mm (or 20-40 mm) in the z-axis, where the z-axis may correspond to depth. In further applications, the field of view of one or more removable probes may be about 20 mm, about 25 mm, about 30 mm, about 35 mm, or about 40 mm along the longitudinal axis and/or at least 20 mm, at least 25 mm, at least 30 mm, at least 35 mm, at least 40 mm, at least 45 mm, at least 50 mm, at least 55 mm, at least 60 mm, at least 65 mm, at least 70 mm, at least 75 mm, or at least 80 mm in the z-axis. In some embodiments, the combined field of view may change with depth (e.g., with scanning distance). For example, at a scanning distance of about 4 mm the field of view may be about 20 mm along the longitudinal axis, and at a scanning distance of about 20-50 mm the field of view may be about 30 mm or less along the longitudinal axis. If most of the motion of the intraoral scanner is done relative to the long axis (e.g., longitudinal axis) of the scanner, then overlap between scans can be substantial. In some applications, the field of view of the combined cameras is not continuous. For example, the intraoral scanner may have a first field of view separated from a second field of view by a fixed separation. The fixed separation may be, for example, along the longitudinal axis of the elongate wand.

In some embodiments, the large FOV of the removable probe 215 increases an accuracy of the detected depth of 3D surfaces. For example, the accuracy of a depth measurement of a detected 3D surface may be based on the longitudinal distance between two cameras or between a light projector and a camera, which may represent a triangulation baseline distance. The level of accuracy may vary from probe to probe, depending on designs of the probes. In embodiments, cameras and/or light projectors may be spaced apart in a configuration that provides for increased accuracy of depth measurements for 3D surfaces that, for example, have a depth of up to 30 mm, up to 40 mm, up to 50 mm, up to 60 mm, and so on.

Different removable probes may be designed for different purposes. For example, one or more first removable probes may be configured for intraoral scanning of standard patients (e.g., where the removable probe may have an intermediate size with about 2-4 structured light projectors and 6-8 cameras), one or more second removable probes for scanning of edentulous patients (e.g., where the removable probe may have a large size that is larger than the intermediate size and may have more light projectors and/or cameras than the one or more first removable probes such as greater than 8 cameras), one or more third removable probes for scanning of child patients (e.g., where the removable probe may have a small size that is smaller than the intermedia size and may have fewer cameras and/or projectors than the one or more first removable probes), one or more fourth removable probes for scanning hard to reach locations (e.g., where the removable probe may have a small size that is smaller than the intermedia size and may have fewer cameras and/or projectors than the one or more first removable probes), and so on. There may also be removable probes that are configured for specific diagnostic purposes, such as removable probes for near infrared (NIR) imaging that include one or multiple near infrared cameras and/or NIR light projectors, removable probes for determining shading and/or coloring of oral surfaces that include multiple different light projectors that project light having different colors, removable probes for 2D or 3D face capture that include one or more cameras configured to have a wide field of view and a deep focus, removable probes for accurate color imaging that include a spectrometer, removable probes for pocket depth measurement that include a pocket depth probe and two or more cameras, and so on. In some embodiments, some removable probes are designed for orthodontics, and may have one or more lower resolution cameras and a high global accuracy while some removable probes are designed for restorative dentistry and may have one or more higher resolution cameras and high local accuracy.

Cameras 220A-D may include any type of image sensor, such as complementary metal oxide (CMOS) and/or charge coupled devices (CCD) image sensors. Depending on the removable probe, cameras 220A-D may be global shutter cameras (cameras with global shutter image sensors) or rolling shutter cameras (cameras with rolling shutter image sensors). In a global shutter camera, the entire image sensor of the camera captures a scene simultaneously. This means that all pixels of the image sensor are exposed to light and/or read at the same time. As a result, there is typically less distortion or artifacts caused, for example, by fast motion. However, global shutter sensors tend to be larger, more complex and more expensive to manufacture compared to rolling shutter sensors. In a rolling shutter camera, the image sensor captures the scene by scanning pixels of the image sensor line by line from top to bottom (or vice versa) over a brief period. This means that each line of the image is exposed at a slightly different time and/or read at a slightly different time. Consequently, if there is any change in the scene during the exposure and/or before pixel values are read, it can lead to distortion or artifacts in the final image. For example, fast-moving objects may appear skewed or bent.

Structured light projectors 222A-C may each include a light source and a pattern generating optical element, such as a mask, a diffractive optical element (DOE), a refractive optical element, and so on. In one embodiment, one or more light projectors 222A-C are configured to project light patterns that have a sparse pattern (e.g., a pattern of spots). When sparse patterns are used, even if the areas of illumination of the light projectors overlap, the number of instances in which pattern features from one light pattern are coincident with pattern features from the other light pattern is greatly reduced. Accordingly, the amount of interference caused by overlapping areas of illumination may be reduced or eliminated by using sparse light patterns (e.g., such as a sparse uniform pattern of spots). In one embodiment, one or more structured light projectors 222A-C are configured to project light patterns that have a dense pattern (e.g., a checkerboard pattern).

For some applications, structured light projectors 222A-C and/or cameras 220A-D are positioned within probe 215 such that each structured light projector 222A-C and/or camera 220A-D faces an object outside of intraoral imaging device 205 that is placed in its field of illumination/view. For example, the structured light projectors 222A-C and/or cameras 220A-D may be directed approximately orthogonal to a longitudinal axis of removable probe 215. Alternatively, or additionally, one or more structured light projectors 222A-C and/or cameras 220A-D are oriented such that they are approximately aligned with a longitudinal axis of the probe 215 and face a mirror that redirects patterned light output by the structured light projectors 222A-C onto the object being scanned and/or that redirects returning light reflected off of the object onto sensors of the cameras 220A-D. For example, one or more structured light projectors 222A-C and/or cameras 220A-D may be oriented approximately parallel to the longitudinal axis of the probe 215 and face a mirror in the probe 215, which redirects structured light projected by the structured light projector(s) onto an object to be imaged. In some embodiments, one or more cameras 220A-D is oriented approximately parallel to the longitudinal axis of the probe 215 and toward a mirror, and views the object by reflection of light off the mirror and into the camera.

In some embodiments, the projectors 222A-C and cameras 220A-D of the removable probe 215 are arranged into component groups (e.g., imaging units) each including one or more structured light projectors and one or more cameras. In embodiments, component groups are arranged in series along the longitudinal axis of the removable probe 215. In an embodiment, each component group includes a projector with two or more cameras disposed about the projector.

For some probes 215, the structured light projectors 222A-C and cameras 220A-D are a distance of less than 20 mm from the object, or less than 15 mm from the object, or less than 10 mm from the object. The distance may be measured as a distance between a camera/structured light projector and a plane orthogonal to an imaging axis of the intraoral imaging device (e.g., where the imaging axis of the intraoral scanner may be perpendicular to a longitudinal axis of the intraoral scanner). Alternatively, the distance may be measured differently for each camera as a distance from the camera to the object 32 along a ray from the camera to the object.

For some probes 215, one or more cameras 220A-D have a large field of view β (beta) of at least 45 degrees, e.g., at least 70 degrees, e.g., at least 80 degrees, e.g., 85 degrees. For some probes, the field of view of one or more cameras may be less than 120 degrees, e.g., less than 100 degrees, e.g., less than 90 degrees. For some probes, a field of view β (beta) one or more cameras is between 80 and 90 degrees, which may be particularly useful because it provides a good balance among pixel size, field of view and camera overlap, optical quality, and cost. A combined FOV and field of illumination 260 of the cameras 220A-D and structured light projectors 222A-C is shown.

Cameras 220A-D may include an image sensor and objective optics including one or more lenses. To enable close focus imaging, cameras 220A-D of some probes 215 may focus at an object focal plane that is located between 1 mm and 30 mm, e.g., between 4 mm and 24 mm, e.g., between 5 mm and 11 mm, e.g., 9 mm-10 mm, from the lens that is farthest from the sensor. For some probes, cameras 220A-D may capture images at a frame rate of at least 30 frames per second, e.g., at a frame of at least 75 frames per second, e.g., at least 100 frames per second. For some probes, the frame rate may be less than 200 frames per second.

For some probes 215, in order to improve image capture, one or more camera 220A-D has a plurality of discrete preset focus positions, where in each focus position the camera focuses at a respective object focal plane. Cameras 220A-D may include an autofocus actuator that selects a focus position from the discrete preset focus positions in order to improve a given image capture. Additionally or alternatively, cameras 220A-D may include an optical aperture phase mask that extends a depth of focus of the camera, such that images formed by each camera are maintained focused over all object distances located between 1 mm and 30 mm, e.g., between 4 mm and 24 mm, e.g., between 5 mm and 11 mm, e.g., 9 mm-10 mm, from the lens that is farthest from the sensor.

For some probes 215, one or more structured light projectors 222A-C may have a large field of illumination a (alpha) of at least 45 degrees, e.g., at least 70 degrees. For some probes 215, field of illumination a (alpha) for one or more light projectors 222A-C may be less than 120 degrees, e.g., than 100 degrees.

By combining multiple cameras and structured light projectors within probe 215, the intraoral imaging device 205 is able to have an overall large field of view while maintaining a low profile probe. A large field of view achieved by combining the respective fields of view of all the cameras (e.g., of multiple component groups) may improve accuracy due to reduced amount of image stitching errors, especially in edentulous regions, where the gum surface is smooth and there may be fewer clear high resolution 3D features. Having a larger field of view enables large smooth features, such as the overall curve of the tooth, to appear in each image frame, which improves the accuracy of stitching respective surfaces obtained from multiple such image frames.

For some removable probes, there is at least one uniform light projector 224 (which may be an unstructured light projector that projects light across a range of wavelengths) coupled to thermally conductive structure 236. Uniform light projector 224 may transmit white light onto an object being scanned. At least one camera, e.g., one of cameras 220A-D, captures two-dimensional color images of the object being scanned using illumination from uniform light projector 224.

Some removable probes include other light sources, such as light sources for fluorescent imaging, for projecting IR or near IR light, and so on.

In some probes 215, structured light projectors 222A-C and cameras 220A-D are coupled to a thermally conductive structure 236 (e.g., in a closely packed and/or alternating fashion), such that (a) a substantial part of each camera's field of view overlaps the field of view of neighboring cameras, and (b) a substantial part of each camera's field of view overlaps the field of illumination of one or more neighboring projectors. Optionally, at least 20%, e.g., at least 50%, e.g., at least 75% of the projected pattern of light are in the field of view of at least one of the cameras at an object focal plane that is located at least 4 mm from the lens that is farthest from the sensor. Due to different possible configurations of the projectors and cameras, some of the projected pattern may never be seen in the field of view of any of the cameras, and some of the projected pattern may be blocked from view by object as the scanner is moved around during a scan.

Thermally conductive structure 236 may be a non-flexible (rigid) structure to which structured light projectors 222A-C and cameras 220A-D are coupled so as to provide structural stability to the optics within probe 215. Coupling all the projectors and all the cameras to a common rigid structure helps maintain geometric integrity of the optics of each structured light projector 222A-C and each camera 220A-D under varying ambient conditions, e.g., under mechanical stress as may be induced by the subject's mouth. Additionally, coupling the projectors and cameras to a rigid structure helps maintain stable structural integrity and positioning of structured light projectors 222A-C and cameras 220A-D with respect to each other.

In embodiments, thermally conductive structure 236 is or includes a heat conducting material such as a metal (e.g., aluminum, copper, etc.). The heat conducting material may contact each of the structured light projectors 222A-C, cameras 220A-D and/or other active elements in the removable probe 215 that may generate heat in embodiments. Heat from the structured light projectors 222A-C, cameras 220A-D and/or other active elements in probe 215 (e.g., white light projector 224) may be transferred to thermally conductive structure 236. Thermally conductive structure 236 may include a first thermal contact configured to mate with a second thermal contact in base 210 (e.g., to be in thermal contact with a heat pipe 240 in base 210). In some embodiments, a thermal interface material (TIM) 242 may be disposed at an end of heat pipe 240 and/or an end of thermally conductive structure 236 to facilitate thermal contact between heat pipe 240 and thermally conductive structure 236. The TIM 242 may be or include a thermal pad, a graphite sheet, a thermally conductive epoxy, and/or other material.

In some embodiments, a mechanical clamp and/or one or more springs are included in the base 210 and/or removable probe 215 to apply pressure between the heat pipe 240 and the thermally conductive structure 236, reducing thermal resistance therebetween.

Base 210 may include a thermal management system configured to remove heat from the removable probe 215. In some embodiments, the thermal management system includes one or more heat pipe 240, one or more heat sink 250 and/or one or more fans 252. Heat pipe 240 may be coupled to a heat sink 250 disposed in the base 210 in some embodiments. In some embodiments, heat pipe 240 is soldered, brazed, and/or mechanically clamped to the heat sink 250. In some embodiments a TIM is disposed between the heat pipe 240 and heat sink 250. One or more fans 252 may be coupled to the heat sink 240. Heat pipe 240 may receive heat from thermally conductive structure 236 and transfer the heat to heat sink 250. In some embodiments, one or more fans 252 may flow air across heat sink 252 to then dissipate the heat. Alternatively, the thermal management system may perform passive cooling, and may not include fans. Accordingly, the base 210 may include a mechanism to remove heat from removable probe 215 and dissipate the removed heat.

In some embodiments, the base 210 lacks a heat pipe that connects to thermally conductive structure 236. In some embodiments, the thermal management system in base 210 comprises a first cavity, and the removable probe 215 comprises a second cavity configured to mate with the first cavity to form an air flow path between the removable probe 215 and the base 210. Base 210 may include one or more fans in the first cavity that move air through the first cavity and the second cavity. The air may cool the removable probe (e.g., by extracting heat from the active elements such as the cameras 220A-D and/or structured light projectors 222A-C of the removable probe 215. In some embodiments, the base 210 and/or removable probe 215 may include one or more vents or openings to enable air to flow into and out of the intraoral imaging device 205.

For some applications, at least one temperature/thermal sensor (not shown) is included in removable probe 215 and measures a temperature of one or more locations withing removable probe 215. Temperature control circuitry (not shown) and/or processing device 246 disposed within base 210 may (a) receive data from a temperature sensor indicative of the temperature of, e.g., thermally conductive structure 236, and (b) activate a thermal management system in the base unit 210 and/or a heating system in the removable probe 215 in response to the received data. The heating system (not shown) may include, for example, one or more heating elements (e.g., resistive heating elements) configured to defog optics and/or surfaces of the removable probe. In one embodiment, the heating system includes one or more heating elements coupled to a transparent element 290 or window disposed on a side of removable probe 215 (e.g., to protect cameras 220A-D and/or structured light projectors 222A-D from exposure to bodily fluids). The transparent element 140 may be glass, plastic, plexiglass, sapphire, or other optically transparent material in embodiments. The heating elements may include, for example, transparent conductors such as indium tin oxide (ITO), fluorine-doped tin oxide (FTO), aluminum-doped zinc oxide (AZO), etc. that may coat a surface of the transparent element 290 or window. The heating elements may alternatively include traditional resistive heating elements that are not in a FOV of the cameras or in a field of illumination of the structured light projectors. The thermal management system and/or heating system may include a temperature control unit, e.g., a PID controller, that keeps removable probe 215 at a target temperature (e.g., between 35 and 43 degrees Celsius, between 37 and 41 degrees Celsius, etc.). Keeping removable probe 215 above 35 degrees Celsius, e.g., above 37 degrees Celsius, reduces fogging of one or more surfaces (e.g., of transparent element 290). Keeping removable probe 215 below 43 degrees, e.g., below 41 degrees Celsius, prevents discomfort or pain.

Base 210 may include one or more first connectors 232 at a distal end of the base 210. Removable probe 215 may include one or more second connectors 230 at a first end of the removable probe 215. The one or more first connectors 232 comprise one or more first contacts and one or more second contacts. Similarly, the one or more second contacts 230 may comprise one or more third contacts and one or more fourth contacts. The one or more first contacts and one or more third contacts may be contacts for a power connection and the one or more second contacts and one or more fourth contacts may be contacts for a data connection in embodiments. In some embodiments, one or more of the contacts may be a male or female contact. For example, first and second contacts may be male contacts (e.g., pins) and third and fourth contacts may be female contacts (e.g., sockets for receiving pins). The one or more third contacts may be configured to mate with the one or more first contacts to provide a power connection between the removable probe 215 and the base 210. Similarly, the one or more fourth contacts may be configured to mate with the one or more second contacts to provide a data connection between the removable probe 215 and the base 210. In some embodiments, the first, second, third and fourth contacts are all electrical contacts. In some embodiments, the first and third contacts are electrical contacts and the second and fourth contacts are optical contacts. Examples of electronical connectors having electrical contacts include mezzanine connectors, flexible printed circuit (FPC) connectors, flat flexible cable (FFC) connectors, micro coax connectors, wire to board connectors, miniature coaxial radio frequency (RF) connectors, and so on. Examples of optical connectors include fiber optic connectors such as a subscriber connector, a lucent connector, a straight tip connector, a ferrule connector, a multi-fiber termination push-on/pull-off connector, an E2000 connector, a miniature unit connector, a subminiature version A (SMA) connector, a mechanical transfer registered jack.

In embodiments, the one or more first connectors 232 and one or more second connectors 230 provide both a power connection and a data connection between base 210 and removable probe 215. The data connection may be configured to carry high-speed mobile industry processor interface (MIPI) signals (e.g., for a plurality of cameras, such as 4, 6, 8, 10, etc. cameras) in some embodiments. Accordingly, the one or more first connectors 232 and one or more second connectors 230 may be configured to handle high data rates while maintaining signal integrity. In embodiments, the one or more first connectors 232 and one or more second connectors 230 carry signals between removable probe 215 and base 210 for activating structured light projectors 222A-C and cameras 220A-D. Such signals may cause cameras 220A-D to generate scan data (e.g., images), which are transferred from removable probe 215 to base 210 via the one or more first connectors 232 and one or more second connectors 230.

The one or more first connectors 232 and one or more second connectors 230 should have a small size to enable them to fit at an end of the base 210 and removable probe 215, respectively. In some embodiments, the connectors 230, 232 have a height of about 7 mm or less (e.g., may be three-row connectors with a height of about 7 mm or less).

In embodiments, one or more first connectors 232 and one or more second connectors 230 are configured to endure a large number of mating cycles. The connectors 230, 232 should be configured to continue to function through the life span of the intraoral imaging device 210. Currently, there are no connectors capable of carrying high speed MIPI signals for a plurality of cameras (e.g., for 6 or more cameras) that are sized to fit into a removable probe 215 and that can sustain a high number of mating cycles. In embodiments, such a connector has been designed for use in intraoral imaging device 205. In embodiments, the connectors 230, 232 are configured to undergo at least 500 mating cycles, at least 1000 mating cycles, at least 1500 mating cycles, at least 2000 mating cycles or more.

In embodiments, base 210 may include a processing device 246 configured to control operation of the intraoral imaging device 210, including operations of the active components (e.g., structured light projectors 222A-C, white light projector 224 and/or cameras 220A-D of removable probe 215. Processing device 246 may be or include, for example, one or more digital signal processors (DSPs), field programmable gate arrays (FPGAs), graphics processing units (GPUs), central processing units (CPUs), application specific integrated circuits (ASICs), embedded microcontrollers (e.g., embedded systems), and so on. Processing device 246 may send control signals to the active components of removable probe via connectors 230, 232, and may receive scan data from cameras 220A-D of removable probe 215 via connectors 230, 232. Processing device 246 may perform operations on the scan data, such as combining intraoral scans into blended scans, filtering scan data, compressing scan data, cropping scan data, processing scan data using one or more trained machine learning models to identify portions of scan data that are unusable or low quality so as not to send such portions of the scan data and thereby consume bandwidth, and so on.

In embodiments, base 210 may further include a memory and/or storage (not) shown connected to processing device 246. The memory may include, for example, a random access memory (RAM) such as dynamic random access memory (DRAM) and/or a read only memory (ROM). The storage may include, for example, a flash storage. Configuration settings, calibration values, etc. associated with one or more removable probes 215 may be stored in the memory and/or storage in some embodiments.

In embodiments, base 210 includes a communications module 254 configured to communicate with a computing device (also referred to as a base unit of an intraoral scanning system), such as computing device 105 of FIG. 1. Communications module 254 may be or include a wireless communication module and/or a wired communication module. For example, communications module 254 may include a Wi-Fi and/or Bluetooth communications module, an Ethernet communications module, an InfiniBand communication module, and so on. Communication module 254 may be, for example, a network interface controller (NIC) capable of communicating via Wi-Fi, via third generation (3G), via fourth generation (4G) and/or fifth generation (5G) telecommunications protocols (e.g., global system for mobile communications (GSM), long term evolution (LTE), Wi-Max, code division multiple access (CDMA), etc.), via Bluetooth, via Zigbee, and/or via other wireless protocols. Alternatively, the communications module 254 may connect to a wide area network (WAN) such as the Internet, and may connect to the computing device and/or a remote server computing device via the WAN. Via the communications module 254, base 210 may receive instructions from the computing device and send data (e.g., a unique ID of the removable probe 215, scan data, etc.) to the computing device.

In addition to or instead of including a wireless communication module, base 210 may include an Ethernet network interface controller (NIC), a universal serial bus (USB) port, a parallel port, a serial port, or other wired port. In some embodiments, the NIC or port may connect the base 210 to a computing device via a wired connection. Depending on whether the base 210 is connected to a computing device via a wired or wireless connection, base 210 may wirelessly send intraoral image data to the computing device or may instead send the intraoral image data to the computing device to which it is connected via a wired connection.

In embodiments, base 210 includes a power supply 256 configured to power the intraoral imaging device. The power supply 256 may be configured to power the intraoral imaging device (including the removable base 215) via power from a power cable and/or via power from an onboard battery. In some embodiments, power supply 256 includes a rechargeable battery from which the power supply may draw power 256 when the base 210 is not plugged into a power source. Power supply 256 may include, for example, a power management integrated circuit (MPIC), a voltage regulator, a charge controller (e.g., for managing a charging process of a rechargeable battery), one or more DC-DC converters, one or more AC-DC converters, one or more boost converters, battery monitoring and protection circuitry, a wireless charging module, and so on.

In some embodiments, removable probe 215 may include one or more additional sensors, such as contact sensors, motion sensors, pressure sensors, pH sensors, temperature sensors, and so on, which may add additional functionality to the removable probe 215.

Different removable probes may have different heights, lengths, widths and/or shapes. The height, length, width, shape, etc. may at least in part be dependent on a configuration, type and/or layout of cameras 220A-D and/or structured light projectors 222A-C in embodiments. As shown, removable probe 215 has height H1 and length L1, wherein the length is a dimension along a longitudinal axis of the removable probe 215.

In some embodiments, base 210 includes one or more cameras and/or light projectors (e.g., structured light projectors). In such embodiments, base 210 and removable probe 215 may include one or more light guides, light pipes, optical fibers and/or waveguides to guide projector light from the light projector(s) in the base 210 through the removable probe 215 and onto an object being imaged and/or returning light through the removable probe 215 and base 210 and onto one or more cameras in base 210. In such embodiments, the removable probes would also include light projectors and/or cameras.

FIG. 2B is a schematic illustration of the modular intraoral imaging device 205 of FIG. 2A with the removable probe 215 disconnected from the base 210, in accordance with some applications of the present disclosure. As shown, the removable probe 215 may be connected to base 210 by pressing the removable probe 215 against the base 210 along a longitudinal axis of the base 210 and/or of the removable probe 215. Similarly, the removable probe 215 may be disconnected from the base 210 by pulling the removable probe from the base 210 along the longitudinal axis of the base 210 and/or of the removable probe 215. In some embodiments, the base 210 and/or removable probe 215 include a button that can be pressed to release a latching mechanism used to secure the removable probe to the base 210. In some embodiments, the latching mechanism is controlled electronically by processing device 246. For example, a user may press a disconnect button on base 210 and/or may select a disconnect option within a GUI of the intraoral imaging application of a computing device connected (via a wired or wireless connection) to intraoral imaging device 205. The computing device may send a disconnect instruction to the intraoral imaging device 205, and processing device 246 may actuate the latching mechanism to release the removable probe 215. In some embodiments, the latching mechanism is a mechanical latching mechanism. In some embodiments, the latching mechanism is a magnetic (e.g., an electromagnetic) latching mechanism.

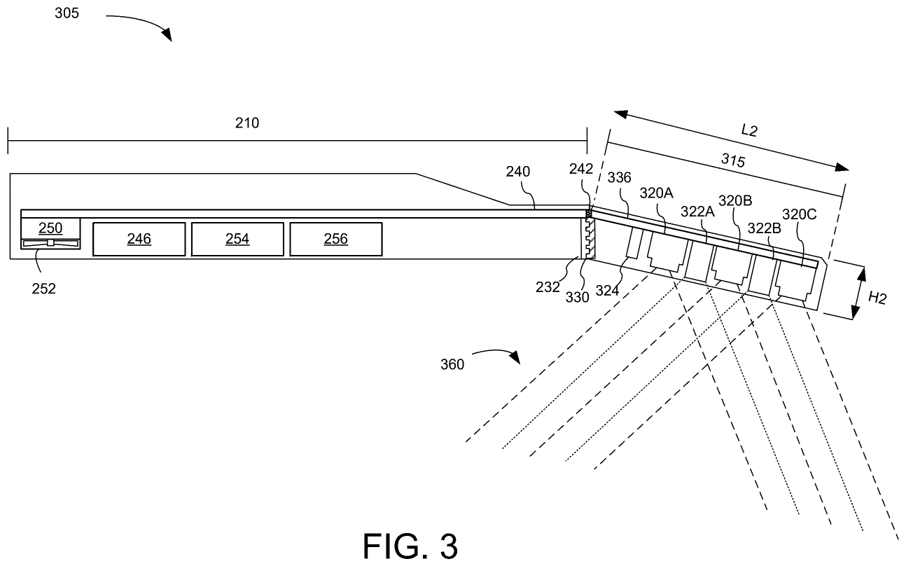

FIG. 3 is a schematic illustration of a modular intraoral imaging device 305, which may include the base 210 of FIG. 2A with a different removable probe 315 connected to the base 210, in accordance with some applications of the present disclosure. As shown base 210 may be a same base as was used in intraoral imaging device 205. However, removable probe 315 is different from removable probe 215 of FIG. 2A. In the illustrated example, removable probe 315 includes a thermally conductive structure 336 connected to multiple structured light projectors 322A-B, multiple cameras 320A-C, and a white light projector 324. Removable probe 315 may include a different arrangement, configuration, number, types, etc. of structured light projectors 322A-B and/or cameras 320A-C as compared to removable probe 215 of FIG. 2A. For example, removable probe 315 is shown to have fewer structured light projectors and cameras than removable probe 215, which may cause a FOV and/or field of illumination of the removable prove 315 to be less than a FOV and/or field of illumination of removable probe 215. Additionally, or alternatively, removable probe 315 may have a different height (e.g., H2), length (e.g., L2), width, shape, etc. than removable probe 215.

In some embodiments, one or more removable probes (e.g., such as removable prove 315) may be configured such that a longitudinal axis of the removable probe 315 is at an angle relative to a longitudinal axis of base 210. This angle may be beneficial for some cases and/or may be preferred by some dental practitioners. Different removable bases 315 may be configured to have different angles relative to the longitudinal axis of the base 210. In some embodiments, the angle between a longitudinal axis of the removable probe 315 and a longitudinal axis of the base 210 is about 0 degrees to about 30 degrees. Other angles may also be used.

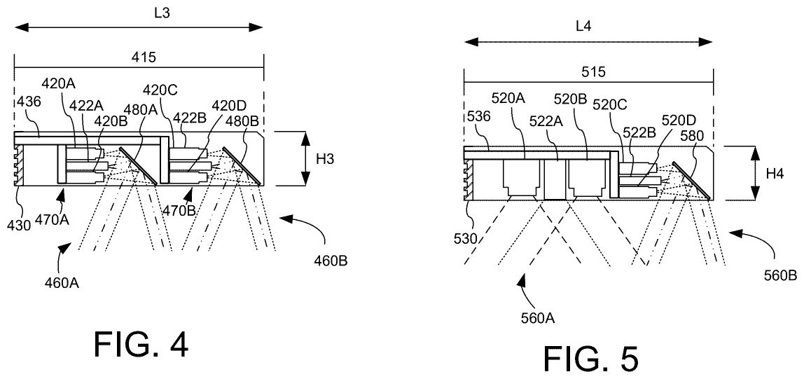

As shown in FIGS. 2A-3, for some removable probe the cameras and structured light projectors are positioned to face towards a surface being scanned. However, other configurations are also possible, such as shown in FIGS. 4-5.

FIG. 4 is a schematic illustration of a removable probe 415 configured for attachment to the base 210 of FIG. 2A, in accordance with some applications of the present disclosure. Removable probe 415 may include one or more connectors 430, which may be the same connectors as connectors 230 of FIG. 2A in embodiments. Removable probe 415 may include a thermally conductive structure 436 connected to multiple structured light projectors 422A-B and multiple cameras 420A-D. Rather than facing towards an object to be imaged, structured light projectors 422A-B and cameras 420A-D may face one or more mirrors 480A-B included in the probe 415, which may reflect the patterned light projected by the one or more structured light projectors 422A-B towards an object to be imaged. The mirror(s) 480A-B may additionally reflect returning light back to cameras 420A-D.

In some embodiments, the projectors 422A-B and cameras 220A-D of the removable probe 415 are arranged into component groups (e.g., imaging units) each including one or more structured light projectors and one or more cameras. In embodiments, component groups are arranged in series along the longitudinal axis of the removable probe 415. In an embodiment, each component group includes a projector with two or more cameras disposed about the projector. For example, a first component group may include a single structured light projector 422A and four cameras (including camera 420A above structured light projector 422A, camera 420B below structured light projector 422A, a third camera (not shown) to a right of the structured light projector 422A and a fourth camera (not shown) to a left of the structured light projector 422A. Similarly, a second component group may include a single structured light projector 422B and four cameras (including camera 420C above structured light projector 422B, camera 420D below structured light projector 422B, a third camera (not shown) to a right of the structured light projector 422B and a fourth camera (not shown) to a left of the structured light projector 422B. The first component group may have a first FOV and/or field of illumination 460A, and the second component group may have a second FOV and/or field of illumination 460B. In some embodiments, the first and second fields of view and/or fields of illumination overlap at one or more depths or distances from the removable probe 415. The amount of overlap may be dependent on an arrangement and/or configuration of the structured light projectors, cameras and/or mirrors in the respective component groups. Different removable probes may be configured to have different amounts of overlap between the fields of view and/or fields of illumination at given distances from the removable probes.

In some embodiments, the overlap between fields of illumination of the different component groups can cause interference that introduces noise and/or lowers a scan quality. Accordingly, in some embodiments one or more techniques are used to mitigate and/or eliminate such interference. Examples of techniques to reduce such interference are discussed in U.S. Application No. 63/656,524, filed Jun. 5, 2024, which is incorporated by reference herein in its entirety.

In some embodiments, mirrors 480A-B include respective defogging elements (e.g., resistive heating elements) that may heat the mirrors to mitigate fogging of the mirrors 480A-B. The defogging elements may be connected to one or more connectors 430 to enable a processing device of a base to control operation of the defogging elements and to prove power to the defogging elements.

As shown, removable probe 415 has a height H3 and a length L3, which may or may not differ from the heights and/or lengths of any of the aforementioned removable probes.

FIG. 5 is a schematic illustration of an additional removable probe 515 configured for attachment to the base 210 of FIG. 2A, in accordance with some applications of the present disclosure. Removable probe 515 may include one or more connectors 530, which may be the same connectors as connectors 230 of FIG. 2A in embodiments. Removable probe 515 may include a thermally conductive structure 536 connected to multiple structured light projectors 522A-B and multiple cameras 520A-D. Removable probe 515 may include a first component group including one or more structured light projectors 522A and one or more cameras 520A-B that face towards an object to be imaged. Additionally, removable probe 515 may include a second component group including one or more structured light projectors 522B and cameras 520C-D that face one or more mirrors 580 included in the probe 515, which may reflect the patterned light projected by the one or more structured light projectors 522B towards an object to be imaged. The mirror(s) 580 may additionally reflect returning light back to cameras 520C-D.

In embodiments, the component groups are arranged in series along the longitudinal axis of the removable probe 515. In an embodiment, each component group includes a projector with two or more cameras disposed about the projector. The first component group may have a first FOV and/or field of illumination 560A, and the second component group may have a second FOV and/or field of illumination 560B. In some embodiments, the first and second fields of view and/or fields of illumination overlap at one or more depths or distances from the removable probe 515. The amount of overlap may be dependent on an arrangement and/or configuration of the structured light projectors, cameras and/or mirrors in the respective component groups.

In some embodiments, the overlap between fields of illumination of the different component groups can cause interference that introduces noise and/or lowers a scan quality. Accordingly, in some embodiments one or more techniques are used to mitigate and/or eliminate such interference, as discussed above.

In some embodiments, mirror 480 includes one or more defogging elements (e.g., resistive heating elements) that may heat the mirror to mitigate fogging of the mirror 480. The defogging element(s) may be connected to one or more connectors 530 to enable a processing device of a base to control operation of the defogging elements and to prove power to the defogging elements.

As shown, removable probe 515 has a height H4 and a length L4, which may or may not differ from the heights and/or lengths of any of the aforementioned removable probes.

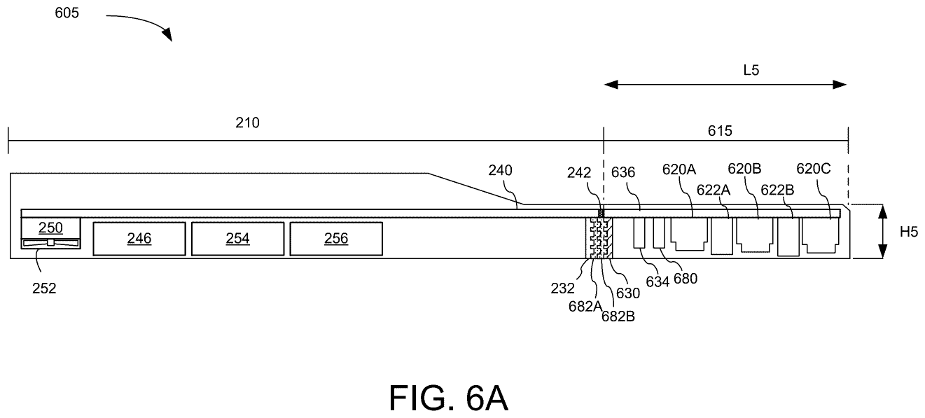

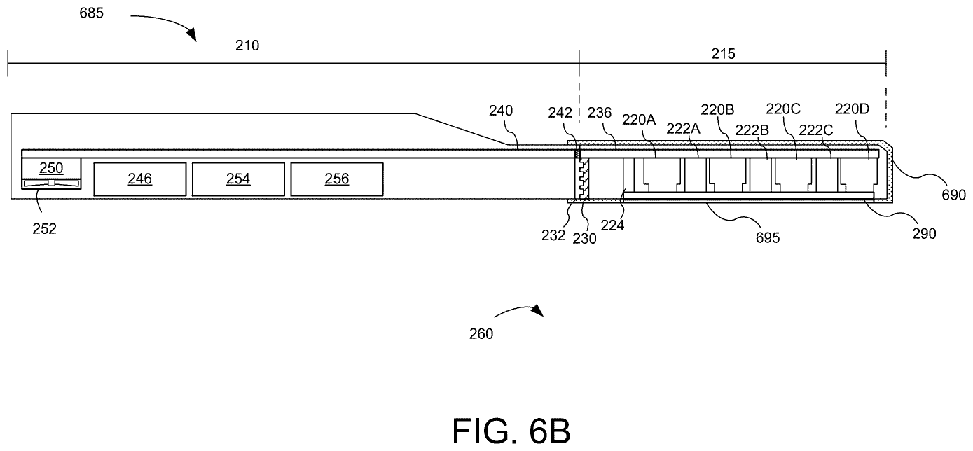

FIG. 6A is a schematic illustration of a modular intraoral imaging device 605 comprising a removable probe 615 connected to a base 210 via a disposable connector (also referred to as a replaceable intermediate connector), in accordance with some applications of the present disclosure. Base 210 may correspond to base 210 of FIG. 2A in embodiments. Removable probe 615 may include one or more connectors 630, which may be the same connectors as connectors 230 of FIG. 2A in embodiments.

In some embodiments, connector(s) 630 and connector(s) 232 may not support (e.g., be rated for) a large enough number of mating cycles. Accordingly, in some embodiments, one or more disposable connectors 682A, 682B are interposed between connector(s) 630 and connector(s) 232. Disposable connector 682B may be configured to connect to connector 630, and disposable connector 682A may be configured to connect to connector 232. Disposable connector 682A may then connect and disconnect from disposable connector 630 for some threshold number of mating cycles for which these disposable connectors are configured or rated (e.g., 20 mating cycles, 50 mating cycles, 100 mating cycles, 250 mating cycles, 500 mating cycles, etc.). Once disposable connector 682B has been used for the preset threshold number of mating cycles, the disposable connector 682B may be disconnected from connector 630 and a new disposable connector may be attached to connector 630. Similarly, once disposable connector 682A has been used for the threshold number of mating cycles, the disposable connector 682A may be disconnected from connector 232 and a new disposable connector may be attached to connector 232. This may increase a number of mating cycles supported by base 210 and removable probe 615 exponentially. For example, if the disposable connectors 682A-B support 100 mating cycles, and connectors 232, 630 support 200 mating cycles, then in combination 20,000 mating cycles may be supported. In some embodiments, intraoral imaging device 150 and/or intraoral scan application 115 tracks a number of mating cycles that have been performed for each connector (e.g., for each disposable connector), and outputs a notice to replace one or more of the disposable connectors once they reach the threshold number of mating cycles. In some embodiments, the intraoral imaging device 150 and/or intraoral imaging application 115 outputs a warning when the number of mating cycles experienced by one or more disposable connectors is close to the threshold number of mating cycles (e.g., is within about 5, 10 or 15 mating cycles of the threshold number of mating cycles).

In some embodiments, disposable connector 682A is used, but disposable connector 682B is not used. Alternatively, disposable connector 682B may be used, but disposable connector 682A may not be used.

Removable probe 615 may include a thermally conductive structure 636 connected to multiple structured light projectors 622A-B and multiple cameras 620A-C. The number, arrangement, type, configuration, etc. of the structured light projectors 622A-B and/or cameras 620A-C may be the same as or different from any of the aforementioned removable probe examples. As shown, removable probe 615 further includes a white light projector 680 and a near infrared (NIR) light projector 634, each of which may project structured or unstructured (e.g., unpatterned) light.

As shown, removable probe 615 has a height H5 and a length L5, which may or may not differ from the heights and/or lengths of any of the aforementioned removable probes.

FIG. 6B is a schematic illustration of a modular intraoral imaging device 685 with a protective sleeve 690, in accordance with some applications of the present disclosure. In the illustrated example, modular intraoral imaging device 685 corresponds to modular intraoral imaging device 205 of FIG. 2A, and includes a plurality of structured light projectors 222A-C, a plurality of cameras 220A-D and a uniform light projector 224 coupled to a thermally conductive structure 236 disposed within a removable probe 215, which is coupled to a base 210 via one or more first connectors 232 at a distal end of the base 210 and one or more second connectors 230 at a first end of the removable probe 215. Probe 215 may include a transparent element 290 or window disposed on a side of removable probe 215. Transparent element 290 may be composed of a material having high optical transmission properties such as glass, plastic, polycarbonate, etc. Base 210 may include a heat pipe 240 to couple to thermally conductive structure 236, optionally via a TIM 242. Base 210 may include a thermal management system comprising one or more heat pipe 240, one or more heat sink 250 and/or one or more fans 252. Base may additionally include a processing device 246, a communications module 254, and/or a power supply 256.

Probe 215 may be inserted into protective sleeve 690, which may cover probe and optionally a portion of base 210. Protective sleeve 690 may conform to a shape of probe 215 in embodiments. In embodiments, protective sleeve 690 covers a contact area between first connector 232 and second connector 230 (and between thermally conductive structure 235 and heat pipe 240). By covering the contact area between first connectors 232 and second connectors 230, the protective sleeve 290 may ensure that bodily fluids of a patient do not reach the contact area. The protective sleeve 290 may include a second transparent element 695 or window that lines up (or approximately lines up) with transparent element 290 of probe 215. Second transparent element 695 may be composed of a material having high optical transmission properties such as glass, plastic, polycarbonate, etc.

Protective sleeve 690 may be removeable and replaceable. In some embodiments, protective sleeve 690 is autoclavable. In an example, the protective sleeve 690 may be removed and disinfected after use with each patient. Alternatively, the protective sleeve 690 may be disposable and replaced after use with each patient. In one example, the protective sleeve 690 may be made of plastic or another inexpensive material.

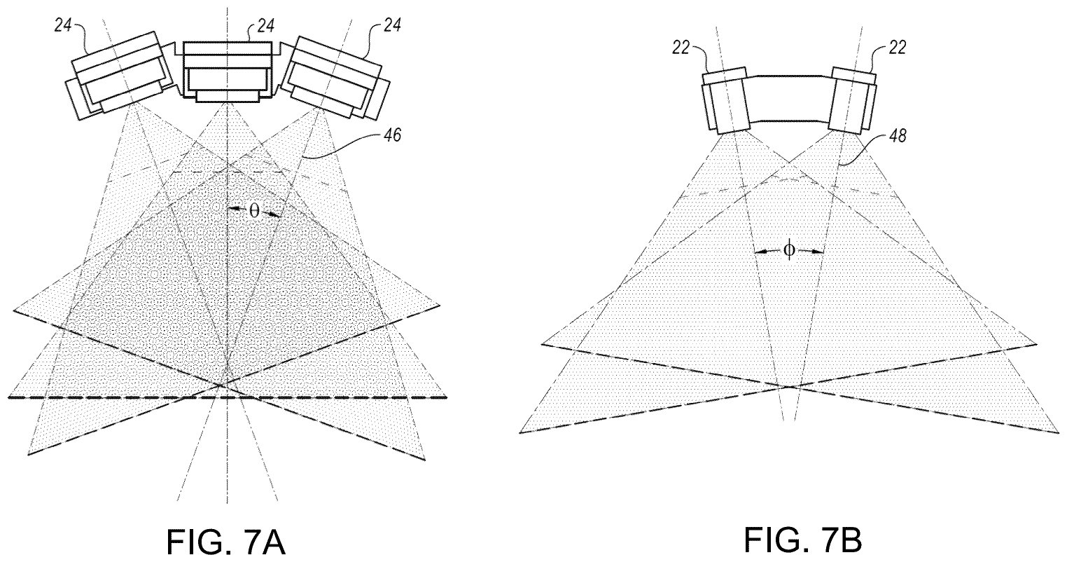

Reference is now made to FIGS. 7A-7B, which include schematic illustrations of a positioning configuration for cameras 24 (which may correspond to any of the aforementioned cameras) and structured light projectors 22 (which may correspond to any of the aforementioned cameras) respectively, in accordance with some applications of the present disclosure. For some applications, in order to improve the overall field of view and field of illumination of the intraoral imaging device, cameras 24 and structured light projectors 22 are positioned such that they do not all face the same direction for some removable probes. For some applications, such as is shown in FIG. 7A, a plurality of cameras 24 are coupled a rigid structure such that an angle θ (theta) between two respective optical axes 46 of at least two cameras 24 is 90 degrees or less, e.g., 35 degrees or less. Similarly, for some applications, such as is shown in FIG. 7B, a plurality of structured light projectors 22 are coupled to a rigid structure such that an angle q (phi) between two respective optical axes 48 of at least two structured light projectors 22 is 90 degrees or less, e.g., 35 degrees or less for some removable probes.

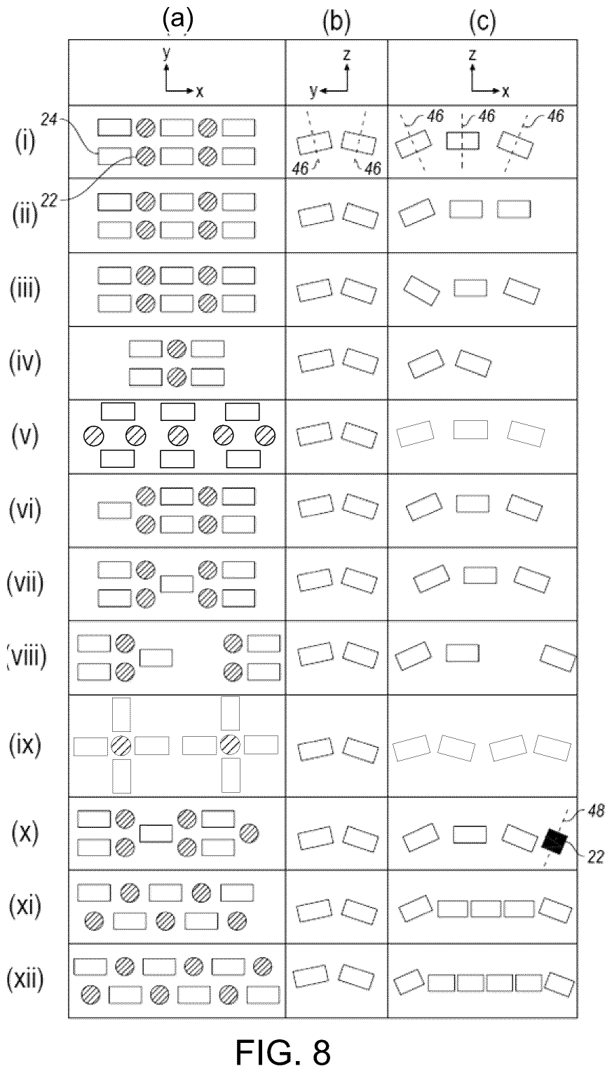

Reference is now made to FIG. 8, which is a chart depicting a plurality of different configurations for the position of structured light projectors 22 and cameras 24 in various different removable probes, in accordance with some applications of the present disclosure. Structured light projectors 22 are represented in FIG. 8 by circles and cameras 24 are represented in FIG. 8 by rectangles. It is noted that rectangles are used to represent the cameras, since typically, each image sensor and the field of view β (beta) of each camera 24 have aspect ratios of 1:2. Column (a) of FIG. 8 shows a bird's eye view of some possible configurations of structured light projectors 22 and cameras 24. The x-axis as labeled in the first row of column (a) corresponds to a central longitudinal axis of a removable probe. Column (b) shows a side view of cameras 24 from the various configurations as viewed from a line of sight that is coaxial with the central longitudinal axis of a removable probe and substantially parallel to a viewing axis of the intraoral imaging device. Similarly to as shown in FIG. 7A, column (b) of FIG. 8 shows cameras 24 positioned so as to have optical axes 46 at an angle of 90 degrees or less, e.g., 35 degrees or less, with respect to each other for some removable probes. Column (c) shows a side view of cameras 24 of the various configurations as viewed from a line of sight that is perpendicular to the central longitudinal axis of probe 28.

For some removable probes, the distal-most (toward the positive x-direction in FIG. 8) and proximal-most (toward the negative x-direction in FIG. 8) cameras 24 are positioned such that their optical axes 46 are slightly turned inwards, e.g., at an angle of 90 degrees or less, e.g., 35 degrees or less, with respect to the next closest camera 24. For some removable probes, the camera(s) 24 that are more centrally positioned, i.e., not the distal-most camera 24 nor proximal-most camera 24, are positioned so as to face directly out of the removable probe, their optical axes 46 being substantially perpendicular to the central longitudinal axis of probe 28. It is noted that in row (xi) a projector 22 is positioned in the distal-most position of probe 28, and as such the optical axis 48 of that projector 22 points inwards, allowing a larger number of pattern features projected from that particular projector 22 to be seen by more cameras 24.

In row (ix) the structured light projectors and cameras are divided into two component groups that are arranged along a longitudinal axis of a removable probe. The first component group includes a structured light projector surrounded by four cameras, where two of the cameras are on a central longitudinal axis of the removable probe and two cameras are offset from the central longitudinal axis of the removable probe. In one embodiment, each of the cameras in the first component group may be tilted towards the structured light projector. The second component group also includes a structured light projector surrounded by four cameras, where two of the cameras are on a central longitudinal axis of the removable probe and two cameras are offset from the central longitudinal axis of the removable probe. In one embodiment, each of the cameras in the second component group may be tilted towards the structured light projector. As shown in row (ix), the cameras and structured light projectors may face towards an object to be scanned (e.g., may be approximately orthogonal to the longitudinal axis of the removable probe. Alternatively (not shown), each component group may be positioned to face approximately parallel to the longitudinal axis of the removable probe toward a mirror (e.g., as shown in a cross sectional side view in FIG. 4).

In embodiments, the number of structured light projectors 22 in a removable probe may range from two, e.g., as shown in row (iv) and row (ix) of FIG. 8, to six, e.g., as shown in row (xii). Typically, the number of cameras 24 in probe 28 may range from four, e.g., as shown in row (iv), to eight, e.g., as shown in row (ix). It is noted that the various configurations shown in FIG. 8 are by way of example and not limitation, and that the scope of the present disclosure includes additional configurations not shown. For example, the scope of the present disclosure includes fewer or more than five projectors 22 positioned in probe 28 and fewer or more than seven cameras positioned in probe 28. With reference to row (v), two outer rows include a series of cameras and an inner row includes a series of projectors.

In an example application, an intraoral imaging device (e.g., intraoral imaging device 150, 205, 305, 605, etc.) includes a base and a removable probe at a distal end of the base, at least two light projectors disposed within the probe, and at least four cameras disposed within the probe. Each light projector may include at least one light source configured to generate light when activated, and a pattern generating optical element that is configured to generate a pattern of light when the light is transmitted through the pattern generating optical element. Each of the at least four cameras may include a camera sensor (also referred to as an image sensor) and one or more lenses, wherein each of the at least four cameras is configured to capture a plurality of images that depict at least a portion of the projected pattern of light on an intraoral surface. A majority of the at least two light projectors and the at least four cameras may be arranged in one or more rows that are each approximately parallel to a longitudinal axis of the probe. In at least one embodiment, as shown in row (v), the intraoral imaging device includes two rows of cameras (e.g., two rows of three cameras each) and a single row of structured light projectors (e.g., two to five structured light projectors) disposed between the two rows of cameras.

In a further application, a distal-most camera along the longitudinal axis and a proximal-most camera along the longitudinal axis of the at least four cameras are positioned such that their optical axes are at an angle of 90 degrees or less with respect to each other from a line of sight that is perpendicular to the longitudinal axis. Cameras in the first row and cameras in the second row and/or third row may be positioned such that optical axes of the cameras in the first row are at an angle of 90 degrees or less with respect to optical axes of the cameras in the second row and/or third row from a line of sight that is coaxial with the longitudinal axis of the probe. A remainder of the at least four cameras other than the distal-most camera and the proximal-most camera may have optical axes that are substantially parallel to the longitudinal axis of the probe in some embodiments. Some of the one or more rows may include an alternating sequence of light projectors and cameras. In some embodiments, some rows contain only projectors and some rows contain only cameras (e.g., as shown in row (v).

In a further application, the distal-most camera along the longitudinal axis and the proximal-most camera along the longitudinal axis are positioned such that their optical axes are at an angle of 35 degrees or less with respect to each other from the line of sight that is perpendicular to the longitudinal axis. The cameras in the first row and the cameras in the second row and/or third row may be positioned such that the optical axes of the cameras in the first row are at an angle of 35 degrees or less with respect to the optical axes of the cameras in the second row and/or third row from the line of sight that is coaxial with the longitudinal axis of the probe.

In a further application, the at least four cameras may have a combined field of view of 25-45 mm along the longitudinal axis and a field of view of 20-40 mm along a z-axis corresponding to distance from the probe.

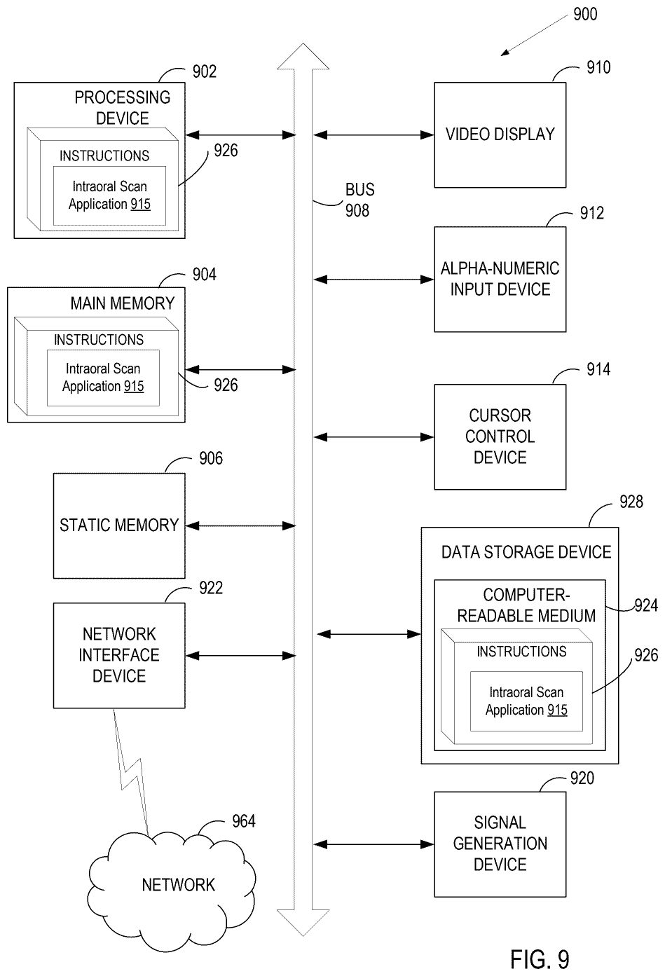

FIG. 9 illustrates a diagrammatic representation of a machine in the example form of a computing device 900 within which a set of instructions, for causing the machine to perform any one or more of the methodologies discussed herein, may be executed. In alternative embodiments, the machine may be connected (e.g., networked) to other machines in a Local Area Network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet computer, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The example computing device 900 includes a processing device 902, a main memory 904 (e.g., read-only memory (ROM), flash memory, dynamic random access memory (DRAM) such as synchronous DRAM (SDRAM), etc.), a static memory 906 (e.g., flash memory, static random access memory (SRAM), etc.), and a secondary memory (e.g., a data storage device 928), which communicate with each other via a bus 908.

Processing device 902 represents one or more general-purpose processors such as a microprocessor, central processing unit, or the like. More particularly, the processing device 902 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 902 may also be one or more special-purpose processing devices such as an application specific integrated circuit (ASIC), a field programmable gate array (FPGA), a digital signal processor (DSP), network processor, or the like. Processing device 902 is configured to execute the processing logic (instructions 926) for performing operations and operations discussed herein.

The computing device 900 may further include a network interface device 922 for communicating with a network 964. The computing device 900 also may include a video display unit 910 (e.g., a liquid crystal display (LCD) or a cathode ray tube (CRT)), an alphanumeric input device 912 (e.g., a keyboard), a cursor control device 914 (e.g., a mouse), and a signal generation device 920 (e.g., a speaker).

The data storage device 928 may include a machine-readable storage medium (or more specifically a non-transitory computer-readable storage medium) 924 on which is stored one or more sets of instructions 926 embodying any one or more of the methodologies or functions described herein. Wherein a non-transitory storage medium refers to a storage medium other than a carrier wave. The instructions 926 may also reside, completely or at least partially, within the main memory 904 and/or within the processing device 902 during execution thereof by the computer device 900, the main memory 904 and the processing device 902 also constituting computer-readable storage media.

The computer-readable storage medium 924 may also be used to store an intraoral imaging application 915, which may correspond to intraoral scan application 115 of FIG. 1. The computer readable storage medium 924 may also store a software library containing methods that call an intraoral scanning module 950, a scan registration module and/or a model generation module. While the computer-readable storage medium 924 is shown in an example embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing or encoding a set of instructions for execution by the machine and that cause the machine to perform any one or more of the methodologies of the present disclosure. The term “computer-readable storage medium” shall accordingly be taken to include, but not be limited to, solid-state memories, and optical and magnetic media.

Below are some example implementations of the invention described herein. These example implementations are not meant to be limiting, and should be construed only as examples.

Example 1: An intraoral imaging device is provided, comprising a base that includes a processing device configured to control operation of the intraoral imaging device, and a first connector located at a distal end of the base. The device further includes a removable probe that comprises one or more structured light projectors configured to project a light pattern, a plurality of cameras configured to image the projected light pattern to produce intraoral image data, and a second connector at a first end of the removable probe. The second connector is configured to mate with the first connector to provide both a power connection and a data connection between the removable probe and the base, wherein the processing device is configured to receive the intraoral image data from the plurality of cameras via the data connection.

Example 2: The intraoral imaging device of example 1 further comprises a power supply configured to power the intraoral imaging device, and a communications module configured to communicate with a computing device. The computing device is configured to receive the intraoral image data from the intraoral imaging device via the communications module.

Example 3: The intraoral imaging device of example 1 or 2 further provides that the first connector comprises one or more first contacts and one or more second contacts, and the second connector comprises one or more third contacts configured to mate with the one or more first contacts to provide the power connection between the removable probe and the base, and one or more fourth contacts configured to mate with the one or more second contacts to provide the data connection between the removable probe and the base.

Example 4: The intraoral imaging device of examples 1-3 further comprises a computing device configured to process the intraoral image data to generate a three-dimensional (3D) model of a dental site based on the intraoral image data. The removable probe has a first probe type, and the computing device is configured to determine, based at least in part on at least one of the intraoral image data or the 3D model of the dental site, that a second probe type is recommended, and to output a recommendation for the second probe type. The removable probe is replaceable with a second removable probe having the second probe type.

Example 5: The intraoral imaging device of example 4 further comprises one or more additional removable probes, each of the one or more additional removable probes comprising the one or more second connectors. The removable probe and the one or more additional removable probes are swappable.

Example 6: The intraoral imaging device of example 5 provides that the removable probe and the one or more additional removable probes are selected from a group consisting of a first probe type comprising a first number of structured light projectors, a first number of cameras, and first dimensions, wherein the first probe type is sized for adult patients, and a second probe type comprising a second number of structured light projectors, a second number of cameras, and second dimensions, wherein the second probe type is sized for child patients.

Example 7: The intraoral imaging device of examples 5-6 provides that the removable probe and the one or more additional removable probes are selected from a group consisting of a first probe type comprising intraoral scanner capabilities, and a second probe type comprising non-intraoral scanner capabilities.

Example 8: The intraoral imaging device of examples 1-7 further comprises a thermal management system disposed in the base and configured to dissipate thermal energy from the removable probe.

Example 9: The intraoral imaging device of example 8 provides that the thermal management system comprises a first thermal contact configured to mate with a second thermal contact of the removable probe, a heat sink, and a heat pipe coupled to the first thermal contact and to the heat sink. The heat pipe is configured to receive the thermal energy via the first thermal contact and the second thermal contact and to dissipate the thermal energy via the heat sink.

Example 10: The intraoral imaging device of examples 8-9 provides that the base comprises a first cavity, the removable probe comprises a second cavity configured to mate with the first cavity to form an air flow path between the probe and the base, and the base comprises a fan configured to cause air to move between the base and the removable probe via the air flow path to cool the removable probe.

Example 11: The intraoral imaging device of examples 1-10 provides that the removable probe comprises a unique identifier that indicates a probe type, and the processing device is configured to determine the probe type based on the unique identifier and to configure one or more parameters of the intraoral imaging device based at least in part on the probe type.

Example 12: The intraoral imaging device of example 11 provides that the processing device is configured to send the unique identifier to the computing device via the communication module, and the computing device is configured to configure one or more settings of an intraoral scan application based at least in part on the probe type.

Example 13: The intraoral imaging device of examples 11-12 provides that the processing device is configured to determine one or more calibration values associated with the unique identifier, and to update a calibration of the intraoral imaging device based on the one or more calibration values.

Example 14: The intraoral imaging device of examples 1-13 further comprises one or more replaceable intermediate connectors disposed between the one or more first connectors and the one or more second connectors, wherein the one or more replaceable intermediate connectors are rated for a threshold number of disconnections and are configured to be replaced by one or more new intermediate connectors once the threshold number of disconnections has been reached.

Example 15: An intraoral imaging device is provided, comprising a base that includes a processing device configured to control operation of the intraoral imaging device, a first removable probe comprising one or more first light projectors configured to project first light, and a first plurality of cameras configured to capture first images under the first light to produce first intraoral image data, and a second removable probe comprising one or more second light projectors configured to project second light, and a second plurality of cameras configured to capture second images under the second light to produce second intraoral image data. The first removable probe and the second removable probe are configured to be interchangeably connected to the base.

Example 16: The intraoral imaging device of example 15 provides that the one or more first light projectors comprise one or more first structured light projectors configured to project a first light pattern, and the one or more second light projectors comprise one or more second structured light projectors configured to project a second light pattern.

Example 17: The intraoral imaging device of examples 15-16 provides that the base further comprises a first connector at a distal end of the base, the first removable probe comprises a second connector at a first end of the first removable probe configured to mate with the first connector to provide a power connection between the first removable probe and the base and to provide a first data connection between the first removable probe and the base, wherein the processing device is configured to receive the intraoral image data from the plurality of cameras via the first data connection, and the second removable probe comprises a third connector at a first end of the second removable probe configured to mate with the first connector to provide a power connection between the second removable probe and the base and to provide a second data connection between the second removable probe and the base, wherein the processing device is configured to receive the intraoral image data from the plurality of cameras via the second data connection.

Example 18: The intraoral imaging device of examples 15-17 provides that the first removable probe has a first probe type and the second removable probe has a second probe type.

Example 19: An intraoral imaging device is provided, comprising a base that includes a processing device configured to control operation of the intraoral imaging device, a power supply configured to power the intraoral imaging device, a communications module configured to communicate with a computing device, and one or more first connectors at a distal end of the base, wherein the one or more first connectors comprise one or more first contacts and one or more second contacts. The device further includes a removable probe comprising one or more structured light projectors configured to project a light pattern, a plurality of cameras configured to image the projected light pattern to produce intraoral image data, and one or more second connectors at a first end of the removable probe. The one or more second connectors comprise one or more third contacts configured to mate with the one or more first contacts to provide a power connection between the removable probe and the base, and comprise one or more fourth contacts configured to mate with the one or more second contacts to provide a data connection between the removable probe and the base. The processing device is configured to receive the intraoral image data from the plurality of cameras via the data connection and to send the intraoral image data to the computing device via the communications module.

Example 20: The intraoral imaging device of example 19 further comprises the computing device, which is configured to process the intraoral image data to generate a three-dimensional (3D) model of a dental site based on the intraoral image data.

Example 21: The intraoral imaging device of example 20, wherein the removable probe has a first probe type, and the computing device is configured to determine, based at least in part on at least one of the intraoral image data or the 3D model of the dental site, that a second probe type is recommended, and to output a recommendation for the second probe type. The removable probe is replaceable with a second removable probe having the second probe type.

Example 22: The intraoral imaging device of examples 19-21 further comprises one or more additional removable probes, each of the one or more additional removable probes comprising the one or more second connectors, wherein the removable probe and the one or more additional removable probes are swappable.

Example 23: The intraoral imaging device of example 22, wherein the removable probe and the one or more additional removable probes are selected from a group consisting of a first probe type comprising a first number of structured light projectors, a first number of cameras, and first dimensions, wherein the first probe type is sized for adult patients, and a second probe type comprising a second number of structured light projectors, a second number of cameras, and second dimensions, wherein the second probe type is sized for child patients.

Example 24: The intraoral imaging device of examples 22-23, wherein the removable probe and the one or more additional removable probes are selected from a group consisting of a first probe type comprising intraoral scanner capabilities and a second probe type comprising non-intraoral scanner capabilities.

Example 25: The intraoral imaging device of examples 19-24 further comprises a thermal management system disposed in the base configured to dissipate thermal energy from the removable probe.

Example 26: The intraoral imaging device of example 25, wherein the thermal management system comprises a first thermal contact configured to mate with a second thermal contact of the removable probe, a heat sink, and a heat pipe coupled to the first thermal contact and to the heat sink, wherein the heat pipe is configured to receive the thermal energy via the first thermal contact and the second thermal contact and to dissipate the thermal energy via the heat sink.

Example 27: The intraoral imaging device of example 26 further comprises a fan in the base coupled to the heat sink to further dissipate the thermal energy.

Example 28: The intraoral imaging device of examples 25-27, wherein the base comprises a first cavity, the removable probe comprises a second cavity configured to mate with the first cavity to form an air flow path between the probe and the base, and the base comprises a fan configured to cause air to move between the base and the removable probe via the air flow path to cool the removable probe.

Example 29: The intraoral imaging device of examples 19-28, wherein the removable probe comprises a unique identifier that indicates a probe type, and the processing device is configured to determine the probe type based on the unique identifier and to configure one or more parameters of the intraoral imaging device based at least in part on the probe type.

Example 30: The intraoral imaging device of example 29, wherein the processing device is configured to send the unique identifier to the computing device via the communication module, and the computing device is configured to configure one or more settings of an intraoral scan application based at least in part on the probe type.

Example 31: The intraoral imaging device of examples 29-30, wherein the processing device is configured to determine one or more calibration values associated with the unique identifier, and to update a calibration of the intraoral imaging device based on the one or more calibration values.

Example 32: The intraoral imaging device of example 31, wherein the removable probe comprises a memory that stores the one or more calibration values, and the processing device is configured to receive the one or more calibration values from the memory via the data connection.

Example 33: The intraoral imaging device of examples 31-32, wherein the processing device is configured to send an inquiry to the computing device for the one or more calibration values associated with the unique identifier and to receive the one or more calibration values from the computing device in response via the communication module.

Example 34: The intraoral imaging device of example 33, wherein the computing device is configured to send a further inquiry to a remote server computing device for the one or more calibration values associated with the unique identifier, to receive the one or more calibration values from the remote server computing device in response, and to send the one or more calibration values to the processing device.

Example 35: The intraoral imaging device of examples 19-34, wherein the one or more first contacts, the one or more second contacts, the one or more third contacts, and the one or more fourth contacts are all electrical contacts.

Example 36: The intraoral imaging device of examples 19-35, wherein the one or more first contacts and the one or more second contacts are electrical contacts, and the one or more third contacts and the one or more fourth contacts are optical contacts.

Example 37: The intraoral imaging device of examples 19-36 further comprises one or more replaceable intermediate connectors disposed between the one or more first connectors and the one or more second connectors, wherein the one or more replaceable intermediate connectors are rated for a threshold number of disconnections and are configured to be replaced by one or more new intermediate connectors once the threshold number of disconnections has been reached.

Example 38: The intraoral imaging device of example 37, wherein the intraoral imaging device is configured to output a notice to replace the one or more intermediate connectors once the threshold number of disconnections has been reached.

Example 39: The intraoral imaging device of examples 19-38, wherein the removable probe comprises a mirror, the plurality of cameras and the one or more structured light projectors are positioned to face the mirror, and the mirror is configured to reflect the projected light pattern onto an object to be scanned and to reflect captured light from the object to be scanned back to the plurality of cameras.

Example 40: The intraoral imaging device of examples 19-39, wherein the plurality of cameras and the one or more structured light projectors are positioned to face directly towards an object to be scanned.

Example 41: The intraoral imaging device of examples 19-40, wherein the one or more structured light projectors and the plurality of cameras are arranged in two or more component groupings, wherein each component grouping comprises a single structured light projector and four or more cameras disposed about the single structured light projector.

Example 42: The intraoral imaging device of examples 19-41, wherein the communications module comprises a wireless communication module and the power supply comprises one or more rechargeable batteries.

Example 43: The intraoral imaging device of examples 19-42 further comprises a heating element in the removable probe configured to defog optics of the removable probe, and a thermal sensor in the removable probe, configured to measure a temperature of the removable probe.

Example 44: The intraoral imaging device of examples 19-43, wherein the base comprises an elongate wand.

Example 45: The intraoral imaging device of examples 19-44, wherein the intraoral imaging device is an intraoral scanner.

Example 46: The intraoral imaging device of examples 19-45 further comprises a thermal management system disposed in the base configured to dissipate thermal energy from the removable probe, wherein the thermal management system comprises a first thermal contact configured to mate with a second thermal contact of the first removable probe, a heat sink, and a heat pipe coupled to the first thermal contact and to the heat sink. The heat pipe is configured to receive the thermal energy via the first thermal contact and the second thermal contact and to dissipate the thermal energy via the heat sink.

It is to be understood that the above description is intended to be illustrative, and not restrictive. Many other embodiments will be apparent upon reading and understanding the above description. Although embodiments of the present disclosure have been described with reference to specific example embodiments, it will be recognized that the disclosure is not limited to the embodiments described, but can be practiced with modification and alteration within the spirit and scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

What is claimed is:

1. An intraoral imaging device, comprising:
a base comprising:
a processing device configured to control operation of the intraoral imaging device; and
a first connector at a distal end of the base; and
a removable probe comprising:
one or more structured light projectors configured to project a light pattern;
a plurality of cameras configured to image the projected light pattern to produce intraoral image data; and
a second connector at a first end of the removable probe configured to mate with the first connector to provide a power connection between the removable probe and the base and to provide a data connection between the removable probe and the base, wherein the processing device is configured to receive the intraoral image data from the plurality of cameras via the data connection.

2. The intraoral imaging device of claim 1, further comprising:
a power supply configured to power the intraoral imaging device; and
a communications module configured to communicate with a computing device, wherein the processing device is to send the intraoral image data to the computing device via the communications module.

3. The intraoral imaging device of claim 1, wherein:
the first connector comprises one or more first contacts and one or more second contacts; and
the second connector comprises one or more third contacts configured to mate with the one or more first contacts to provide the power connection between the removable probe and the base and one or more fourth contacts configured to mate with the one or more second contacts to provide the data connection between the removable probe and the base.

4. The intraoral imaging device of claim 1, further comprising:
the computing device, configured to process the intraoral image data to generate a three-dimensional (3D) model of a dental site based on the intraoral image data;
wherein the removable probe has a first probe type;
wherein the computing device is configured to:
determine, based at least in part on at least one of the intraoral image data or the 3D model of the dental site, that a second probe type is recommended; and
output a recommendation for the second probe type; and
wherein the removable probe is replaceable with a second removable probe having the second probe type.

5. The intraoral imaging device of claim 1, further comprising:
one or more additional removable probes, each of the one or more additional removable probes comprising the second connector, wherein the removable probe and the one or more additional removable probes are swappable.

6. The intraoral imaging device of claim 5, wherein the removable probe and the one or more additional removable probes are selected from a group consisting of:
a first probe type comprising a first number of structured light projectors, a first number of cameras, and first dimensions, wherein the first probe type is sized for adult patients; and
a second probe type comprising a second number of structured light projectors, a second number of cameras, and second dimensions, wherein the second probe type is sized for child patients.

7. The intraoral imaging device of claim 5, wherein the removable probe and the one or more additional removable probes are selected from a group consisting of:
a first probe type comprising intraoral scanner capabilities; and
a second probe type comprising non-intraoral scanner capabilities.

8. The intraoral imaging device of claim 1, further comprising:
a thermal management system disposed in the base configured to dissipate thermal energy from the removable probe.

9. The intraoral imaging device of claim 8, wherein the thermal management system comprises:
a first thermal contact configured to mate with a second thermal contact of the removable probe;
a heat sink; and
a heat pipe coupled to the first thermal contact and to the heat sink, wherein the heat pipe is configured to receive the thermal energy via the first thermal contact and the second thermal contact and to dissipate the thermal energy via the heat sink.

10. The intraoral imaging device of claim 8, wherein:
the base comprises a first cavity;
the removable probe comprises a second cavity configured to mate with the first cavity to form an air flow path between the probe and the base; and
the base comprises a fan configured to cause air to move between the base and the removable probe via the air flow path to cool the removable probe.

11. The intraoral imaging device of claim 1, wherein:
the removable probe comprises a unique identifier that indicates a probe type; and
the processing device is configured to determine the probe type based on the unique identifier and to configure one or more parameters of the intraoral imaging device based at least in part on the probe type.

12. The intraoral imaging device of claim 11, wherein:
the processing device is configured to send the unique identifier to the computing device; and
the computing device is configured to configure one or more settings of an intraoral scan application based at least in part on the probe type.

13. The intraoral imaging device of claim 11, wherein:
the processing device is configured to determine one or more calibration values associated with the unique identifier, and to update a calibration of the intraoral imaging device based on the one or more calibration values.

14. The intraoral imaging device of claim 1, further comprising:
one or more replaceable intermediate connectors disposed between the first connector and the second connector, wherein the one or more replaceable intermediate connectors are rated for a threshold number of disconnections and are configured to be replaced by one or more new intermediate connectors once the threshold number of disconnections has been reached.

15. An intraoral imaging device, comprising:
a base comprising a processing device configured to control operation of the intraoral imaging device;
a first removable probe comprising:
one or more first light projectors configured to project first light; and
a first plurality of cameras configured to capture first images under the first light to produce first intraoral image data; and
a second removable probe comprising:
one or more second light projectors configured to project second light; and
a second plurality of cameras configured to capture second images under the second light to produce second intraoral image data;
wherein the first removable probe and the second removable probe are configured to be interchangeably connected to the base.

16. The intraoral imaging device of claim 15, wherein the one or more first light projectors comprise one or more first structured light projectors configured to project a first light pattern, and wherein the one or more second light projectors comprise one or more second structured light projectors configured to project a second light pattern.

17. The intraoral imaging device of claim 15, wherein:
the base further comprises a first connector at a distal end of the base;
the first removable probe comprises a second connector at a first end of the first removable probe configured to mate with the first connector to provide a power connection between the first removable probe and the base and to provide a first data connection between the first removable probe and the base, wherein the processing device is configured to receive the intraoral image data from the plurality of cameras via the first data connection; and
the second removable probe comprises a third connector at a first end of the second removable probe configured to mate with the first connector to provide a power connection between the second removable probe and the base and to provide a second data connection between the second removable probe and the base, wherein the processing device is configured to receive the intraoral image data from the plurality of cameras via the second data connection.

18. The intraoral imaging device of claim 15, wherein the first removable probe has a first probe type and the second removable probe has a second probe type.

19. An intraoral imaging device, comprising:
a base comprising:
a processing device configured to control operation of the intraoral imaging device;
a power supply configured to power the intraoral imaging device;
a communications module configured to communicate with a computing device; and
one or more first connectors at a distal end of the base, wherein the one or more first connectors comprise one or more first contacts and one or more second contacts; and
a removable probe comprising:
one or more structured light projectors configured to project a light pattern;
a plurality of cameras configured to image the projected light pattern to produce intraoral image data; and
one or more second connectors at a first end of the removable probe, wherein the one or more second connectors comprise one or more third contacts configured to mate with the one or more first contacts to provide a power connection between the removable probe and the base and comprise one or more fourth contacts configured to mate with the one or more second contacts to provide a data connection between the removable probe and the base, wherein the processing device is configured to receive the intraoral image data from the plurality of cameras via the data connection and to send the intraoral image data to the computing device via the communications module.

20. The intraoral imaging device of claim 19, further comprising:
a thermal management system disposed in the base configured to dissipate thermal energy from the removable probe, wherein the thermal management system comprises:
a first thermal contact configured to mate with a second thermal contact of the first removable probe;
a heat sink; and
a heat pipe coupled to the first thermal contact and to the heat sink, wherein the heat pipe is configured to receive the thermal energy via the first thermal contact and the second thermal contact and to dissipate the thermal energy via the heat sink.
